(19) United States
(12) Patent Application Publication
(10) Pub. No.: US 2011/0138439 A1
(43) Pub. Date: Jun. 9, 2011

(54) Reception device, reception method, transmission device, and transmission method

(75) Inventor: Kazuaki Toba, Kanagawa (JP)

(73) Assignee: Sony Corporation, Tokyo (JP)

(21) Appl. No.: 12/924,455

(22) Filed: Sep. 28, 2010

(30) Foreign Application Priority Data
Oct. 16, 2009 (JP) P2009-239115

(51) Int. Cl. H04L 27/00; G09G 5/00; H04N 7/16

(52) U.S. Cl. 725/148; 375/316; 345/660; 725/151; 375/295

(57) ABSTRACT

A receiving device includes a first data receiving unit to receive image data from an external device, with multiple channels, by differential signals, via a transfer path; a second data receiving unit to receive predetermined data from the external device, via a bi-directional communication path made up using predetermined lines of the transfer path; a capability confirming unit to confirm the existence of capability to transmit the predetermined data to the external device, via the bi-directional communication path; and a transmission request unit to request transmission of the predetermined data to the external device when confirmation is made by the capability confirming unit that the external device has the capability.

### CROSS-REFERENCE TO RELATED APPLICATION

The present application claims priority from Japanese Patent Application No. JP 2009-239115 filed in the Japanese Patent Office on Oct. 16, 2009, the entire content of which is incorporated herein by reference.

### BACKGROUND OF THE INVENTION

1. Field of the Invention

The present invention relates to a reception device, reception method, transmission device, and transmission method, and particularly relates to a reception device and so forth that, when an external device has transmission capability of predetermined data, receives predetermined data from the external device via a bi-directional communication path.

2. Description of the Related Art

Heretofore, interfaces such as HDMI (High Definition Multimedia Interface) and the like have come into widespread use as communication interfaces that transfer image and audio data at a high speed from a source device to a sink device. A source device is a gaming device, DVD (Digital Versatile Disc) recorder, set-top box, and other AV sources (Audio Visual source), for example. A sink device is a television receiver, projector, and other display devices, for example. For example, High-Definition Multimedia Interface Specification Version 1.4, Jun. 5, 2009, describes the details of the HDMI standards.

### SUMMARY OF THE INVENTION

Heretofore, a two-screen display with a television receiver, for example, has been realized. The two-screen display herein is from images from one digitally connected source device and internal tuner, for example. That is to say, with a television receiver currently, a two-screen display with images from two digitally connected source devices has not been realized.

There has been found demand to enable readily realizing two-screen display with images from two digitally connected source devices.

According to an embodiment of the present invention, a receiving device includes: a first data receiving unit to receive image data from an external device, with multiple channels, by differential signals, via a transfer path; a second data receiving unit to receive predetermined data from the external device, via a bi-directional communication path made up using predetermined lines of the transfer path; a capability confirming unit to confirm the existence of capability to transmit the predetermined data to the external device, via the bi-directional communication path; and a transmission request unit to request transmission of the predetermined data to the external device when confirmation is made by the capability confirming unit that the external device has the capability.

According to an embodiment of the present invention, a transmitting device includes: a first data transmitting unit to transmit image data to an external device, with multiple channels, by differential signals, via a transfer path; a second data transmitting unit to transmit predetermined data to the external device, via a bi-directional communication path made up using predetermined lines of the transfer path; a capability confirming response unit to respond as to the confirmation of the existence of capability to transmit the predetermined data to the external device, via the bi-directional communication path; and a transmission request unit to receive transmission requests of the predetermined data from the external devices, wherein the second data transmitting device transmits the predetermined data to the external device via the bi-directional communication path, when the transmission request is received with the transmission request receiving unit.

According to the above-described configurations, with the first data transmitting unit of the transmitting device, image data is transmitted to a receiving device (external device) with multiple channels, by differential signals, via a transfer path. With the first data receiving unit of the receiving device, image data is received from the transmitting device (external device) with multiple channels, by differential signals, via a transfer path. Also, with the second data transmitting unit of the transmitting device, predetermined data is transmitted to the external device, via a bi-directional communication path configured using predetermined lines of a transfer path. With the second data receiving unit of the receiving device, predetermined data is received from the transmitting device, via the bi-directional communication path made up using predetermined lines of the transfer path.

With the capability confirming unit of the receiving device, the existence of capability to transmit predetermined data via the bi-directional communication path is confirmed. In response to the confirmation herein, the capability confirming unit of the receiving device responds to the receiving device as to this confirmation, that there is the capability thereof. The confirmation of the existence of capability and the response thereto are performed via a control data line of the transfer path, for example. For example, the transfer path is an HDMI cable, and the control data line is a CEC line. With the control data line, for example an HDMI/CEC network is configured.

When confirmation is made that the transmitting device has capability, the transmission request unit of the receiving device requests a transmission of predetermined data to the transmitting device. Thus when the transmitting request is received, as described above the second data transmitting unit of the transmitting device transmits predetermined data to the receiving device, via the bi-directional communication path. The request for transmission is performed via a control data line of the transfer path, for example.

Thus, confirmation is made as to whether or not the transmitting device has capability to transmit predetermined data from the receiving device via the bi-directional communication path, and when there is capability, transmission of predetermined data is requested from the receiving device to the transmitting device. According to the request thereof, predetermined data is transmitted from the transmitting device to the receiving device via the bi-directional communication path. Therefore, with the receiving device, when the transmitting device has capability to transmit predetermined data via the bi-directional communication path, the predetermined data herein can be used.

For example, predetermined data received with the second data receiving unit of the receiving device may be small-screen image data to display small-screen images of a predetermined size. In this case, for example, small-screen image data is generated based on image data transmitted by the first data transmitting unit, by the image data generating unit at the transmitting device. Thus, at the receiving device, two-screen display is performed, based on image data received by the first data receiving unit and small-screen image data received by the second data receiving unit with the image display unit.

Now, there is a case wherein the reception of image data by the first data receiving unit and the reception of small-screen image data by the second data receiving unit are performed via the same transfer path, and there is a case wherein this is performed via different transfer paths. As a case of being performed via the same transfer path, for example, a repeater device of the transmitting device may be considered, wherein the repeater device herein has a configuration of multiple source devices being connected. On the other hand, as a case of being performed via different transfer paths, a configuration may be considered wherein the receiving device has connection units of multiple transfer paths, and the multiple source devices are connected.

For example, the small-screen image data serving as predetermined data becomes non-compressed image data. In this case the data does not have to be encoded on the transmitting device side or decoded on the receiving device side, processing load is reduced, and two-screen display can be readily performed.

According to the present invention, an arrangement may be made wherein, for example, the receiving device further has a control information transmitting unit to transmit the control information which controls the operations of the transmitting device (external device) to transmit predetermined data received by the second data receiving unit, to the transmitting device thereof, and the transmitting device further has a control information receiving unit to receiving the control information transmitted from the receiving device (external device) via the bi-directional communication path. In this case, the receiving device can control the operations of the transmitting device via the bi-directional communication path. In this case, for example, even in the case that a certain transmitting device becomes a sub source device which only transmits predetermined data via the bi-directional communication path, and the operations there can no longer be controlled via the control data line of the transfer path, the receiving device can perform operation control of the transmitting device herein.

Also, an arrangement may be made wherein, for example, the receiving device (external device) and the transmitting device itself are built into a network using the bi-directional communication path, the transmitting device further has a deactivate request unit to request deactivation as to an activator of the network. The deactivate request is performed via the control data line making up the transfer path, for example. In this case, since the receiving device and transmitting device are separated from the network, transmission of predetermined data using the bi-directional communication path from the transmitting device to the receiving device, i.e. small-screen image data or the like, can be smoothly performed without obstruction to access by other devices.

According to embodiments of the present invention, with the receiving device, when the transmitting device has the capability to transmit predetermined data via the bi-directional communication path, the predetermined data herein can be used, and for example, two-screen display with the two digitally connected source devices can be readily realized.

### BRIEF DESCRIPTION OF THE DRAWINGS

FIG. 1 is a block diagram illustrating a configuration example of an AV system according to a first embodiment of the present invention;

FIG. 2 is a diagram illustrating an image display example in the case of a user performing a picture-in-picture display operation while a television receiver is in the state of displaying an image from an internal tuner;

FIG. 3 is a diagram illustrating an image display example wherein a small-screen image that is one-eighth the size of the disc player is inserted in the image from the internal tuner;

FIG. 4 is a diagram illustrating an image display example in the case of a user performing a picture-in-picture display operation while a television receiver is in the state of displaying an image from a gaming device;

FIG. 5 is a diagram illustrating an image display example wherein a small-screen image that is one-eighth the size of the disc player is inserted in the image from the gaming device;

FIG. 6 is a block diagram illustrating a configuration example of a television receiver of the AV system according to the first embodiment;

FIG. 7 is a block diagram illustrating a configuration example of a gaming device of the AV system according to the first embodiment;

FIG. 8 is a block diagram illustrating a configuration example of a disc player of the AV system according to the first embodiment;

FIG. 9 is a block diagram illustrating a configuration example of an HDMI transmission unit (HDMI source) and HDMI reception unit (HDMI sink);

FIG. 10 is a block diagram illustrating a configuration example of an HDMI transmitter and an HDMI receiver;

FIG. 11 is a diagram illustrating an example of a TMDS transfer data configuration that is transferred with an HDMI TMDS channel;

FIG. 12 is a diagram illustrating a pin array (type A) of HDMI terminals provided on the HDMI device;

FIG. 13 is a diagram illustrating a configuration example of a high-speed data line interface of a source device and sink device;

FIG. 14 is a sequence diagram illustrating a sequence example of a two-screen display of the AV system according to the first embodiment;

FIG. 15 is a diagram illustrating a data configuration of CEC that is transferred by a CEC line of an HDMI cable;

FIG. 16 is a diagram illustrating a data configuration of a header block making up the CEC data;

FIG. 17 is a diagram illustrating an example of a logical address set according to type of various devices;

FIG. 18 is a flowchart (1 of 2) describing processing procedures of a television receiver in the event of a two-screen display with the AV system according to the first embodiment;

FIG. 19 is a flowchart (2 of 2) describing processing procedures of a television receiver in the event of a two-screen display with the AV system according to the first embodiment;

FIG. 20 is a flowchart (1 of 2) describing processing procedures of source devices (source 1, source 2) in the event of a two-screen display with the AV system according to the first embodiment;

FIG. 21 is a flowchart (2 of 2) describing processing procedures of source devices in the event of a two-screen display with the AV system according to the first embodiment;

FIG. 22 is a block diagram illustrating a configuration example of a disc player of an AV system according to a second embodiment;

FIG. 23 is a block diagram illustrating a configuration example of an AV receiver of the AV system according to the second embodiment; and

FIG. 24 is diagram schematically illustrating the flow of AV data and control data between a television receiver, gaming device, and disc player.

### DESCRIPTION OF THE PREFERRED EMBODIMENTS

Embodiments of the present invention (hereafter, “embodiments”) will be described below. Note that description will be given in the following order.

1. First Embodiment

2. Second Embodiment

3. Modification

### 1. First Embodiment

### Configuration of AV System

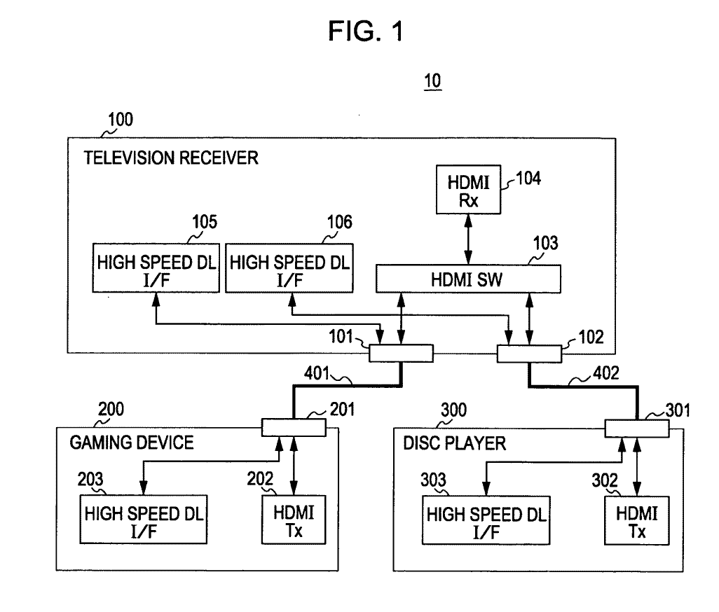

FIG. 1 shows a configuration example of an AV (Audio and visual) system 10 serving as a first embodiment. The AV system 10 herein is made up with a television receiver 100 serving as a sink device, and a gaming device 200 and disc player 300 serving as source devices, connected to one another. With the AV system 10, the various devices support a communication function that uses a bi-directional communication path with a utility line and HPD line which make up an HDMI cable, i.e., supports an HEC (HDMI Ethernet Channel).

The television receiver 100 and gaming device 200 are connected via an HDMI cable 401. Also, the television receiver 100 and disc player 300 are connected via an HDMI cable 402. The television receiver 100 is provided with an HDMI terminal 101 connected to an HDMI receiving unit (HDMI Rx) 104 via an HDMI switcher (HDMISW) 103, and also connected to a high-speed data line interface (high speed DL I/F) 105. Also, the television receiver 100 is provided with an HDMI terminal 102 connected to the HDMI receiving unit 104 via the HDMI switcher 103, and also connected to a high-speed data line interface (high speed DL I/F) 106.

The gaming device 200 is provided with an HDMI terminal 201 to which an HDMI transmitting unit (HDMITx) 202 and high speed data line interface (high speed DL I/F) 203 are connected. Also, the disc player 300 is provided with an HDMI terminal 301 connected to an HDMI transmitting unit (HDMITx) 302 and high speed data line interface (high speed DL I/F) 303.

One end of the HDMI cable 401 is connected to the HDMI terminal 101 of the television receiver 100, and the other end of the HDMI cable 401 is connected to the HDMI terminal 201 of the gaming device 200. Also, one end of the HDMI cable 402 is connected to the HDMI terminal 102 of the television receiver 100, and the other end of the HDMI cable 402 is connected to the HDMI terminal 301 of the disc player 300.

With the AV system 10 shown in FIG. 1, images and audio from the internal tuner can be viewed/listened to with the television receiver 100.

Also, images and audio from the gaming device 200 can be viewed/listened to with the television receiver 100. In this case, non-compressed images and audio data is transmitted from the HDMI transmitting unit 202 of the gaming device 200 to the television receiver 100 with a TMDS channel of the HDMI cable 401. With the television receiver 100, the HDMI terminal 101 is connected to the HDMI receiving unit 104 with the HDMI switcher 103. Therefore, non-compressed images and audio data is obtained from the gaming device 200 with the HDMI receiving unit 104, and image display and audio output of the gaming device 200 is performed.

Also, images and audio from the disc player 300 can be viewed/listened to with the television receiver 100. In this case, non-compressed images and audio data is transmitted from the HDMI transmitting unit 302 of the disc player 300 to the television receiver 100 with a TMDS channel of the HDMI cable 402. With the television receiver 100, the HDMI terminal 102 is connected to the HDMI receiving unit 104 with the HDMI switcher 103. Therefore, non-compressed images and audio data is obtained from the disc player 300 with the HDMI receiving unit 104, and image display and audio output of the disc player 300 is performed.

With the AV system 10 shown in FIG. 1, an image of the gaming device 200 or disc player 300 can be displayed as a small-screen image in the state of displaying an image of an unshown internal tuner with the television receiver 100. In this case, small-screen image data of a predetermined size is generated with the gaming device 200 or disc player 300. That is to say, normally, scaling processing such as thinning is performed as to the full-size image data transmitted with the TMDS (Transition Minimized Differential Signaling) channel, and small-screen image data obtained. The small-screen image data is transmitted from the gaming device 200 or disk player 300 to the television receiver 100, via the above-described bi-directional communication path (HEC).

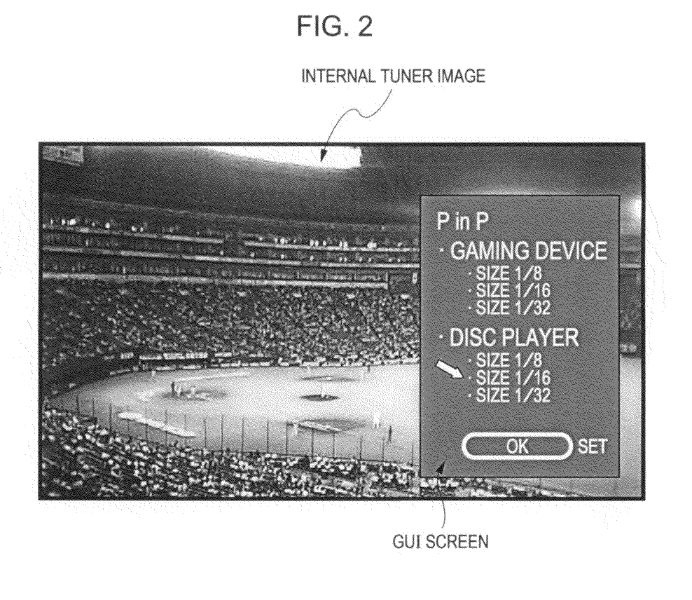

FIG. 2 shows an image display example with the television receiver 100 in the case that the user performs a picture-in-picture (P in P) display operation in the state of displaying an image from the internal tuner. In this case, a GUI (Graphical User Interface) screen in order to select the small-screen image and the size thereof is displayed on the image from the internal tuner.

With the AV system 10 shown in FIG. 1, the various devices support a communication function that uses a bi-directional communication path (HEC), as described above. The GUI screen in FIG. 2 shows an example in the case that exchange of image data can be made in the various image formats of ⅛ size, 1/16 size, and 1/32 size between the television receiver 100 and the gaming device 200 and disc player 300.

Note that the image formats of various sizes are identified by codes. For example, “code 1” indicates an image format of 1/16 size, “code 2” indicates an image format of 1/18 size, and “code 3” indicates an image format of 1/32 size. Details of image formats for the various codes are as follows, for example. Note that full-size is 1920×1080 pixels.

Code 1: non-compressed 1/16 size (480×270 pixels), 1/2 frame (30 fps)

Code 2: non-compressed ⅛ size (680×380 pixels), 1/4 frame (15 fps)

Code 3: non-compressed 1/32 size (340×190 pixels), 1/1 frame (60 fps)

The transfer rate of the small-screen image data in the image formats shown by these various codes becomes a maximum transfer rate of the bi-directional communication path (HEC), e.g. a value smaller than 100 Mbps, for example. For example, in the case of the image format of “code 1”, one pixel is an RGB or YCbCr 24-bit display. For example, in the case of the image format of “code 1”, the transfer rate RT of the small-screen image data is RT=24×480×270×30=93.312 Mbps, and becomes a value smaller than 100 Mbps.

Based on the GUI screen in FIG. 2, when the user selects one of the sizes (⅛, 1/16, 1/32) of the gaming device 200, the image from the gaming device 200 is selected as the small-screen image. In this case, the small-screen image data in the image format corresponding to the selected size is generated with the gaming device 200. The generated small-screen image data is then transmitted from the gaming device 200 to the television receiver 100 via the bi-directional communication path (HEC). Two-screen display wherein the small-screen image of the gaming device 200 is inserted in the image from the internal tuner is performed on the television receiver 100.

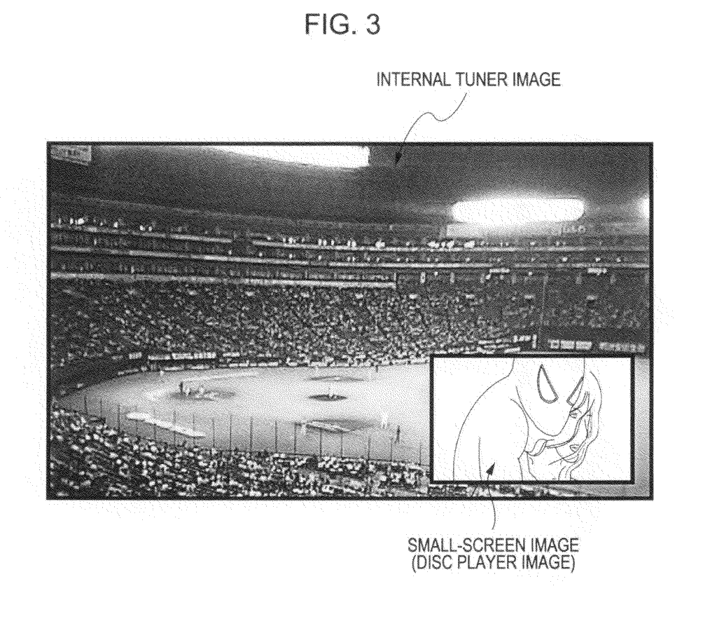

Also, based on the GUI screen in FIG. 2, when the user selects one of the sizes (⅛, 1/16, 1/32) of the disc player 300, the image from the disc player 300 is selected as the small-screen image. In this case, the small-screen image data in the image format corresponding to the selected size is generated with the disc player 300. The generated small-screen image data is then transmitted from the disc player 300 to the television receiver 100 via the bi-directional communication path. Two-screen display wherein the small-screen image of the disc player 300 is inserted in the image from the internal tuner is performed on the television receiver 100. FIG. 3 shows an image display example wherein a ⅛ size small-screen image from the disc player 300 is inserted in the image from the internal tuner.

Also, with the AV system 10 shown in FIG. 1, the image from the internal tuner or disc player 300 can be displayed as the small-screen image in the state of the image from the gaming device 200 being displayed on the television receiver 100. In this case, full-size image data is transmitted from the gaming device 200 to the television receiver 100 by a TMDS channel. Also, in this case, small-screen image data of a predetermined size is generated with the television receiver 100 or disc player 300. In the case of displaying the image from the disc player 300 as the small-screen image, the small-screen image data herein is transmitted from the disc player 300 to the television receiver 100, using the above-described bi-directional communication path (HEC).

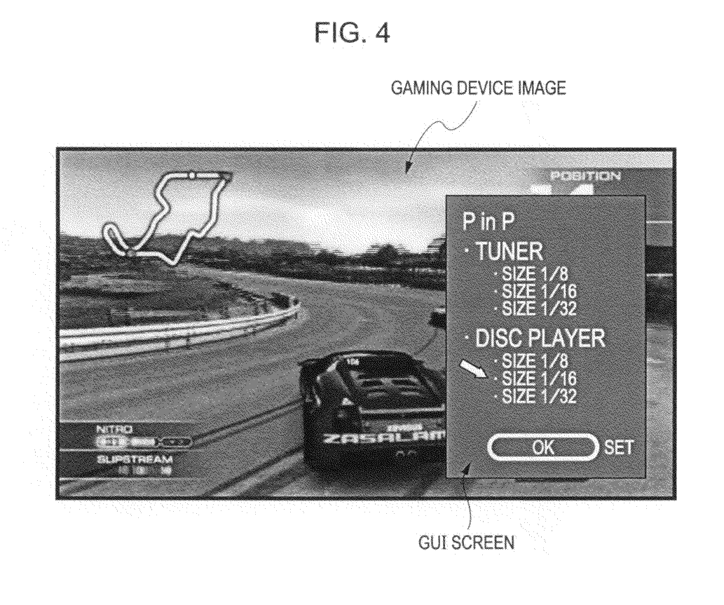

FIG. 4 shows an image display example on the television receiver 100 in the case of the user performing a picture-in-picture (P in P) display operation in the state of displaying an image from the gaming device 200. In this case, a GUI screen to select the small-screen image and the size thereof is displayed on the image from the gaming device 200. The GUI screen in FIG. 4 shows an example in the case that exchange of image data in the various image formats of ⅛ size, 1/16 size, and 1/32 size can be made between the television receiver 100 and disc player 300. Also, the GUI screen in FIG. 4 shows an example in the case that the television receiver 100 can generate image data from the internal tuner in ⅛ size, 1/16 size, and 1/32 size.

Based on the GUI screen in FIG. 4, when the user selects one of the sizes (⅛, 1/16, 1/32) of the internal tuner, the image from the internal tuner is selected as the small-screen image. In this case, the small-screen image data of the selected size is generated with the television receiver 100. Two-screen display wherein the small-screen image of the internal tuner is inserted in the image from the gaming device 200 is performed on the television receiver 100.

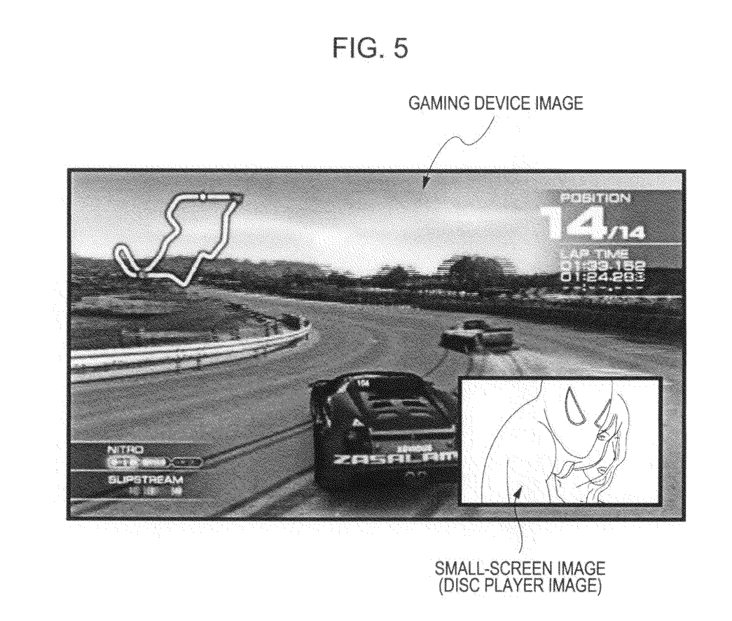

Also, based on the GUI screen shown in FIG. 4, when the user selects one of the sizes (⅛, 1/16, 1/32) of the disc player 300, the image from the disc player 300 is selected as the small-screen image. In this case, the small-screen image data in the image format corresponding to the selected size is generated with the disc player 300. The generated small-screen image data is transmitted from the disc player 300 to the television receiver 100 via the bi-directional communication path. Two-screen display wherein the small-screen image of the disc player 300 is inserted in the image from the gaming device 200 is performed on the television receiver 100. FIG. 5 shows an image display example of a ⅛ size small-screen image from the disc player 300 inserted in the image from the gaming device 200.

Also, with the AV system 10 shown in FIG. 1, images from the internal tuner or gaming device 200 can be displayed as a small-screen image in the state of displaying an image from the disc player 300 with the television receiver 100. In this case, full-size image data is transmitted from the disc player 300 to the television receiver 100 with the TMDS channel. Also, in this case, small-screen image data of a predetermined size is generated with the television receiver 100 or gaming device 200. In the case of displaying the image from the gaming device 200 as the small-screen image, the small-screen image data herein is transmitted from the gaming device 200 to the television receiver 100, using the above-described bi-directional communication path (HEC).

### Configuration Example of Television Receiver

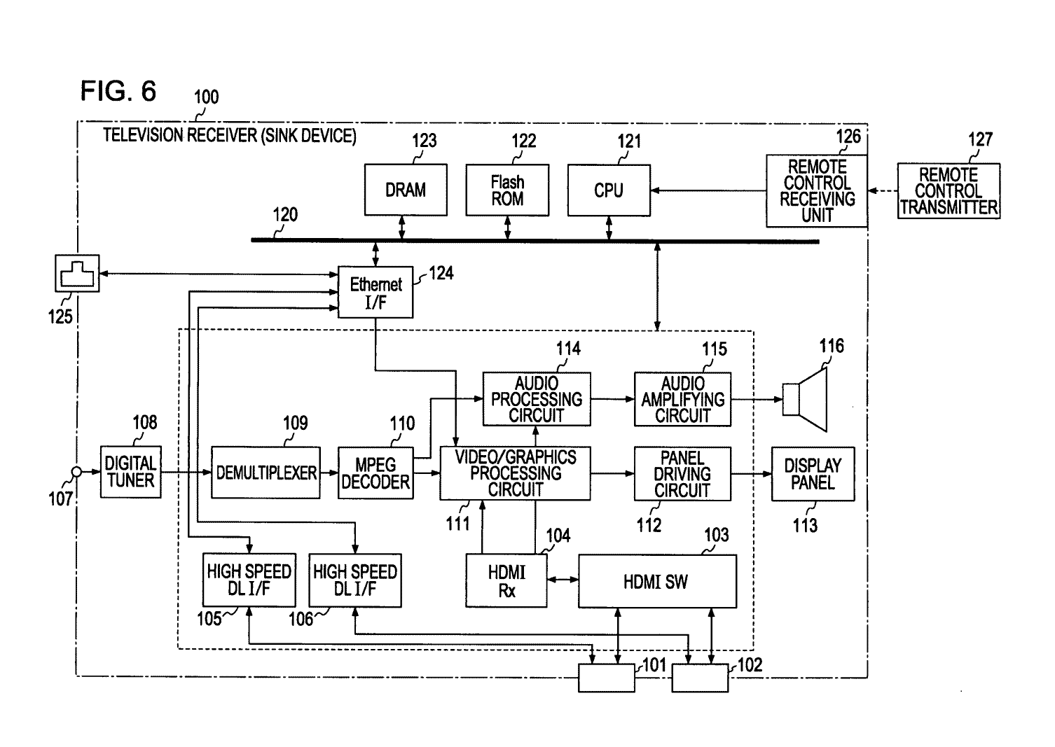

FIG. 6 shows a configuration example of the television receiver 100. The television receiver 100 has HDMI terminals 101 and 102, HDMI switcher 103, HDMI receiving unit (HDMIRx) 104, and high speed data line interfaces (high speed DL I/F) 105 and 106. Also, the television receiver 100 has an antenna terminal 107, digital tuner 108, de-multiplexer 109, and MPEG (MOVING Picture Expert Group) decoder 110.

Also, the television receiver 100 has a video/graphics processing circuit 111, panel driving circuit 112, display panel 113, audio processing circuit 114, audio amplifying circuit 115, and speaker 116. Also, the television receiver 100 has an internal bus 120, CPU 121, flash ROM 122, and DRAM 123. Also, the television receiver 100 has an Ethernet interface 124, network terminal 125, remote control receiving unit 126, and remote control transmitter 127.

The antenna terminal 107 is a terminal to input television broadcast signals received with an unshown reception antenna. The digital tuner 108 processes television broadcast signal input into the antenna terminal 107, and outputs a predetermined transport stream corresponding to the channel selected by the user. The de-multiplexer 109 extracts a partial TS (Transport Stream) corresponding to the channel selected by the user, from the transport stream obtained with the digital tuner 108. This partial TS includes an image data TS packet and audio data TS packet.

Also, the de-multiplexer 109 takes PSI/SI (Program Specific Information/Service Information) from the transport stream obtained with the digital tuner 108, and outputs this to the CPU 121. Multiple channels are multiplexed in the transport stream obtained with the digital tuner 108. Processing to extract the partial TS of an optional channel from the transport stream with the de-multiplexer 109 is enabled by obtaining information of the packet ID (PID) of an optional channel from the PSI/SI (PAT/PMT).

The MPEG decoder 110 performs decoding processing as to video PES (Packetized Elementary stream) packets that are made up of TS packets of image data obtained with the de-multiplexer 109, and obtains image data. Also, the MPEG decoder 110 performs decoding processing as to audio PES packets that are made up of TS packets of audio data obtained with the de-multiplexer 109, and obtains audio data.

The video/graphics processing circuit 111 performs image synthesis processing, superimposing processing of the GUI screen, and so forth at the time of picture-in-picture display. In other words, in the case that the user has performed a picture-in-picture display operation, the video/graphics processing circuit 111 superimposes the GUI screen for selected the small-screen image and the size thereof onto the large-screen image (see FIGS. 2 and 4).

Also, in the case of performing picture-in-picture display wherein the small-screen image from the gaming device 200 is inserted in the image from the internal tuner, the video/graphics processing circuit 111 synthesizes the small-screen image data from the gaming device 200 with the image data obtained from the MPEG decoder 110. In this case, the small-screen image data from the gaming device 200 is transmitted from the gaming device 200 via the bi-directional communication path (HEC) of the HDMI cable 401, and is supplied from the Ethernet interface 124 to the video/graphics processing circuit 111.

Also, in the case of performing picture-in-picture display wherein the small-screen image from the disc player 300 is inserted in the image from the internal tuner, the video/graphics processing circuit 111 performs the following processing. That is to say, the video/graphics processing circuit 111 synthesizes the small-screen image data from the disc player 300 to the image data obtained with the MPEG decoder 110. In this case, the small-screen image data from the disc player 300 is transmitted from the disk player 300 via the bi-directional communication path (HEC) of the HDMI cable 402, and is supplied from the Ethernet interface 124 to the video/graphics processing circuit 111. Also, in the case of performing picture-in-picture display wherein the small-screen image from the gaming device 200 or disc player 300 is inserted in the image from the internal tuner, the following processing is performed. That is to say, the video/graphics processing circuit 111 performs scaling processing as to the image data obtained with the MPEG decoder 110 and generates small-screen image data. The video/graphics processing circuit 111 then synthesizes the generated small-screen image data with the image data obtained with the HDMI receiving unit 104.

Also, in the case of performing picture-in-picture display wherein the small-screen image from the disc player 300 or gaming device 200 is inserted in the image from the disc player 300 or gaming device 200, the following processing is performed. That is to say, the video/graphics processing circuit 111 synthesizes the small-screen image data from the disc player 300 or gaming device 200 to the image data obtained with the HDMI receiving unit 104. In this case, the small-screen image data from the disc player 300 or gaming device 200 is transmitted from the disc player 300 or gaming device 200 via the bi-directional communication path (HEC) of the HDMI cable. The small-screen image data is supplied to the video/graphics processing circuit 111 from the Ethernet interface 124.

The panel driving circuit 112 drives a display panel 113, based on the image data output from the video/graphics processing circuit 111. The display panel 113 is made up of an LCD (Liquid Crystal Display), PDP (Plasma Display Panel), Organic EL (Organic Electro-Luminescence) display, and so forth, for example. The audio processing circuit 114 performs appropriate processing such as D/A conversion or the like as to the audio data obtained with the MPEG decoder 110. The audio amplifying circuit 115 amplifies the audio signals output from the audio processing circuit 114 and supplies this to the speaker 116.

The CPU 121 controls the various parts of the television receiver 100. Also, the CPU 121 performs communication of control information between the gaming device 200 and disc player 200 through an HDMI/CEC network made up of a CEC line which is the control data line of the HDMI cables 401 and 402. The flash ROM 122 stores the control software and holds data. The DRAM 123 makes up the work area of the CPU 121. The CPU 121 opens the software and data read out from the flash ROM 122 on the DRAM 123 and starts up the software, controls the various parts of the television receiver 100, and also performs communication of control information between the gaming device 200 and disk player 300.

With the television receiver 100, the user can perform display operations for picture-in-picture (small-screen display request). In this case, the CPU 121 transmits a <confirm HEC small-screen capability> command to the gaming device 200 and disc player 300 through the HDMI/CEC network. This command is a command to query the gaming device 200 and disc player 300 as to whether or not there is capability to transmit small-screen image data in the image format that can be received by the television receiver 100. Therefore, a code indicating the image format receivable by the television receiver 100 is appended to the command. Note that the <confirm HEC small-screen capability> command is currently not defined as a standard command.

In response to the <confirm HEC small-screen capability> command, when the gaming device 200 and disc player 300 has such capability, a <HEC small-screen capability response> command is transmitted through the HDMI/CEC network. Of the image formats receivable by the television receiver 100, a code indicating the image format that can be transmitted with the gaming device 200 and disc player 300 is appended to the command. With the television receiver 100, this code is used as size information for the GUI screen displayed on the large-screen image in the event that the user has performed picture-in-picture display operations as described above. Note that the <HEC small-screen capability response> command is currently not defined as a standard command.

Note that, in response to the <confirm HEC small-screen capability> command, when the gaming device 200 and disc player 300 have no such capability, a <Feature Abort> command is transmitted through the HDMI/CEC network. With the television receiver 100, the device that transmitted the <Feature Abort> command is not displayed on the GUI screen displayed on the large-screen image in the event that the user has performed picture-in-picture display operations as described above.

Also, with the television receiver 100, the user can select the size of the gaming device 200 or disc player 300 on the GUI screen displayed on the large-screen image, and can select the display of the small-screen images thereof. In this case, the CPU 121 transmits a <request HEC small-screen transfer start> command to the gaming device 200 or disc player 300, through the HDMI/CEC network. This command is a command to request the gaming device 200 or disc player 300 to transmit the small-screen image data. A code indicating the image format of the size selected by the user is appended to the command herein. Note that <request HEC small-screen transfer start> command is not currently defined as a standard command.

In response to the <request HEC small-screen transfer start> command, small-screen image data in the image format corresponding to the appended code is generated at the gaming device 200 or disc player 300 having received this command. The small-screen image data thereof is then transmitted via the bi-directional communication path (HEC).

Also, with the television receiver 100, the user can perform picture-in-picture display stopping operations (small-screen stopping request) in the state that the small-screen image from the gaming device 200 or disc player 300 is displayed. In this case, the CPU 121 transmits a <request HEC small-screen transfer stop> command to the gaming device 200 or disc player 300 through the HDMI/CEC network. This command is a command to request the transmission of the small-screen image data to be stopped. The generation of small-screen image data and the transmission thereof is stopped at the gaming device 200 or disc player 300 having received this command. Note that the <request HEC small-screen transfer stop> command is currently not defined as a standard command.

Also, with the television receiver 100, the user can perform small-screen image enlarging operations during a picture-in-picture display (two-screen display). In this case, when the small-screen image is from the gaming device 200 or disc player 300, the CPU 121 transmits a <request HEC small-screen transfer stop/expand> command to the gaming device 200 or disc player 300 thereof, through the HDMI/CEC network. This command is a command to request the gaming device 200 or disc player 300 to stop transmission of the small-screen image data and to request transmission of full-size image data and audio data from the HDMI transmission unit with a TMDS channel. Generation of the small-screen image data and the transmission thereof is stopped at the gaming device 200 or disc player 300 having received this command, and transmission of full-size image data and audio data from the HDMI transmission unit with a TMDS channel is started. Note that the <request HEC small-screen transfer stop/enlarge> command is currently not defined as a standard command.

The remote control receiving unit 126 receives a remote control signal (remote control code) transmitted from the remote control transmitter 127, and supplies this to the CPU 121. The CPU 121, flash ROM 122, DRAM, 123, and Ethernet interface 124 are connected to the internal bus 120.

The HDMI switcher 103 selectively connects the HDMI terminals 101 and 102 to the HDMI receiving unit 104. The HDMI receiving unit 104 is selectively connected to the HDMI terminal 101 or HDMI terminal 102 via the HDMI switcher 103. The HDMI receiving unit 104 receives non-compressed (base band) image and audio data transmitted uni-directionally from the gaming device 200 and disc player 300 connected to the HDMI terminals 101 and 102, with communication following HDMI standards. Details of the HDMI receiving unit 104 will be described later.

The high speed data line interface 105 and 106 is a bi-directional communication path (HEC) interface made up of predetermined lines of an HDMI cable connected to the HDMI terminals 101 and 102 (in the case of the present embodiment, utility line and HPD line). The high speed data line interfaces 105 and 106 are inserted between the Ethernet interface 124 and the HDMI terminals 101 and 102. Details of the high speed data line interfaces 105 and 106 will be described later.

The operations of the television receiver 100 shown in FIG. 6 will be described briefly. The television broadcast signals input in the antenna terminal 107 are supplied to the digital tuner 108. With the digital tuner 108, television broadcast signals are processed, a predetermined transport stream corresponding to the channel selected by the user is output, and the predetermined transport stream herein is supplied to the de-multiplexer 109. With the de-multiplexer 109, a partial TS (image data TS packets, audio data TS packets) corresponding to the channel selected by the user is extracted from the transport stream. The partial TS herein is supplied to the MPEG decoder 110.

With the MPEG decoder 110, decoding processing is performed as to the video PES packets which are made up of the image data TS packets, and the image data is obtained. The image data herein is supplied to the video/graphics processing circuit 111. Also, with the MPEG decoder 110, decoding process as to the audio PES packets which are made up of audio data TS packets, and the audio data is obtained. The audio data herein is supplied to the audio processing circuit 114.

Also, with the HDMI receiving unit 104, the image data and audio data input into the HDMI terminals 101 or 102 is obtained through the HDMI cable. The image data obtained with the HDMI receiving unit 104 is supplied to the video/graphics processing circuit 111. Also, the audio data obtained with the HDMI receiving unit 104 is supplied to the audio processing circuit 114.

When the display of the internal tuner image is selected by user operations, the image data obtained with the MPEG decoder 110 is selected by the video/graphics processing circuit 111, and the image data is supplied to the panel driving circuit 112. Therefore, the internal tuner image corresponding to the channel selected by the user is displayed on the display panel 113. Also, at this time, the audio data obtained with the MPEG decoder 110 is selected with the audio processing circuit 114, processing for D/A conversion and the like is performed as to the audio data, and the data is supplied to the speaker 116 via the audio amplifying circuit 115. Therefore, the internal tuner audio corresponding to the channel selected by the user is output from the speaker 116.

Also, when the display of the image from the gaming device 200 is selected by user operations, the HDMI terminal 101 is connected to the HDMI receiving unit 104 by the HDMI switcher 103. Therefore, the images and audio data from the gaming device 200 are obtained with the HDMI receiving unit 104. The image data obtained with the HDMI receiving unit 104 is selected by with the video/graphics processing circuit 111, and the image data herein is supplied to the panel driving circuit 112. Therefore, the image from the gaming device 200 is displayed on the display panel 113. Also, at this time, the audio data obtained with the HDMI receiving unit 104 is selected with the audio processing circuit 114, processing for D/A conversion and the like is performed as to the audio data, and the data is supplied to the speaker 116 via the audio amplifying circuit 115. Therefore, the audio from the gaming device 200 is output from the speaker 116.

Also, when the display of the image from the disc player 300 is selected by user operations, the HDMI terminal 102 is connected to the HDMI receiving unit 104 by the HDMI switcher 103. Therefore, the images and audio data from the disc player 300 are obtained with the HDMI receiving unit 104. The image data obtained with the HDMI receiving unit 104 is selected by with the video/graphics processing circuit 111, and the image data herein is supplied to the panel driving circuit 112. Therefore, the image from the disc player 300 is displayed on the display panel 113. Also, at this time, the audio data obtained with the HDMI receiving unit 104 is selected with the audio processing circuit 114, processing for D/A conversion and the like is performed as to the audio data, and the data is supplied to the speaker 116 via the audio amplifying circuit 115. Therefore, the audio from the disc player 300 is output from the speaker 116.

When the user performs display operations for picture-in-picture in the state of the internal tuner image being displayed on the display panel 113, the small-screen image and the GUI screen for selecting the size thereof is superimposed on the internal tuner image and displayed (see FIG. 2). In this case, with the CPU 121, the <confirm HEC small-screen capability> command is transmitted to the gaming device 200 and disc player 300, upon which the <HEC small-screen capability response> command or the <Feature Abort> command is received. Thereby, with the CPU 121, information as to whether or not the gaming device 200 and disc player 300 have the capability to transmit small-screen image data via a bi-directional communication path (HEC) and information of transmittable image formats is obtained.

When the user selects the gaming device 200 size based on the GUI screen and instructs the selection of the small-screen image thereof, transmitting the <request HEC small-screen transfer start> command to the gaming device 200 is performed with the CPU 121. Also, when the user selects the disc player 300 size based on the GUI screen and instructs the selection of the small-screen image thereof, transmitting the <request HEC small-screen transfer start> command to the disc player 300 is performed with the CPU 121. A code indicating the image format for the size selected by the user is appended to this command. With the gaming device 200 or disc player 300, this command generates the small-screen image data in the image format of the size selected by the user, and the small-screen image data is transmitted via the bi-directional communication path (HEC).

The small-screen image data herein is supplied from the Ethernet interface 124 to the video/graphics processing circuit 111. With the video/graphics processing circuit 111, the small-screen image data from the gaming device 200 or the disc player 300 is synthesized with the image data obtained with the MPEG decoder 110. Therefore, a two-screen display is performed on the display panel 113 wherein a small-screen image from the gaming device 200 or the disc player 300 has been inserted (see FIG. 3).

Also, when the user performs display stopping operations of the picture-in-picture in the case of the above-described two-screen display being performed, the <request HEC small-screen transfer stop> command is transmitted to the gaming device 200 or disc player 300 with the CPU 121. With this command, the generation and transmission of the small-screen image data with the gaming device 200 or disc player 300 is stopped. Therefore, small-screen image data from the Ethernet interface 124 to the video/graphics processing circuit 111 is no longer supplied, and the two-screen display is stopped.

Also, when the user performs display enlarging operations of the small screen in the case of the above-described two-screen display being performed, the <request HEC small-screen transfer stopping/enlarging> command is transmitted to the gaming device 200 or disc player 300 with the CPU 121. With this command, the generation and transmission of the small-screen image data with the gaming device 200 or disc player 300 is stopped, and transmission of full-size image data and audio data from the HDMI transmission unit with the TMDS channel is started.

With the HDMI switcher 103, the HDMI terminal connected to the device on the side that the small-screen image has been displayed, of the HDMI terminals 101 and 102, is connected to the HDMI receiving unit 104. Therefore, with the HDMI receiving unit 104, the image data and audio data from the device on the side that the small-screen image has been displayed is obtained.

The image data obtained with the HDMI receiving unit 104 is selected with the video/graphics processing circuit 111, and the image data herein is supplied to the panel driving circuit 112. Therefore, a full-size image from the device on the side that the small-screen image has been displayed, of the gaming device 200 or disc player 300, is displayed on the display panel 113. Also, at this time, the audio data obtained with the HDMI receiving unit 104 is selected with the audio processing circuit 114, processing for D/A conversion and so forth is performed as to the audio data thereof, and this is supplied to the speaker 116 via the audio amplifying circuit 115. Therefore, audio from the device on the side that the small-screen image has been displayed is output from the speaker 116.

When the user performs displaying operations for picture-in-picture while in the state that images from the gaming device 200 or disc player 300 are displayed on the display panel 113, a GUI screen for selecting the small-screen image and the size thereof is superimposed on the image thereof and displayed (see FIG. 4). In this case, with the CPU 121, the <confirm HEC small-screen capability> command is transmitted to the gaming device 200 and disc player 300, upon which the <HEC small-screen capability response> command or <Feature Abort> command is received. Therefore, with the CPU 121, information as to whether or not the gaming device 200 and disc player 300 have the capability to transmit small-screen image data via the bi-directional communication path (HEC) and information of the transmittable image formats are obtained.

Note that in this case, the CPU 121 does not have to transmit the <confirm HEC small-screen capability> command to both the gaming device 200 and disc player 300. This is because in this case, only information as to whether or not the device on the side that the image is not displayed on the display panel 113 has the capability to transmit the small-screen image data and information of the transmittable image formats have to be obtained. In this case, the CPU 121 only has to transmit the <confirm HEC small-screen capability> command to the device on the side that the image is not displayed on the display panel 113, and receive the <HEC small-screen capability response> command or <Feature Abort> command from the device thereof.

When the user selects the size of the internal tuner image based on the GUI screen and instructions selection of the small-screen image thereof, scaling processing is performed as to the image data from the MPEG decoder 110 and small-screen image data is generated at the video/graphics processing circuit 111. At the video/graphics processing circuit 111, the generated small-screen image data is synthesized with the image data obtained with the HDMI receiving unit 104. Therefore, a two-screen display is performed on the display panel 113 wherein a small-screen image from the internal tuner has been inserted into the image from the gaming device 200 or the disc player 300.

Also, when the user performs picture-in-picture display stopping operations in the state that the above-described two-screen display is being performed, the generation and synthesizing of the small-screen image data as to the image data obtained with the MPEG decoder 110 is stopped at the video/graphics processing circuit 111. Therefore, the two-screen display is stopped.

Also, when the user performs enlarging operations of the small-screen in the state that the above-described two-screen display is being performed, generation of the small-image data based on the image data obtained with the MPEG decoder 110 is stopped at the video/graphics processing circuit 111. Also, at the video/graphics processing circuit 111, the image data obtained with the MPEG decoder 110 is selected, and the image data herein is supplied to the panel driving circuit 112. Therefore, a full-size image of the internal tuner is displayed on the display panel 113. Also, at this time, the audio data obtained with the MPEG decoder 110 is selected with the audio processing circuit 114, processing for D/A conversion and so forth is performed as to the audio data, and this is supplied to the speaker 116 via the audio amplifying circuit 115. Therefore, the audio from the internal tuner is output from the speaker 116.

Also, when the user selects the size of the disc player 300 based on the GUI screen and instructs the selection of the small-screen image thereof, at the CPU 121 the <request HEC small-screen transfer start> command is transmitted to the disc player 300. Also, when the user selects the size of the gaming device 200 based on the GUI screen and instructs the selection of the small-screen image thereof, at the CPU 121 the <request HEC small-screen transfer start> command is transmitted to the gaming device 200. A code indicating the image format of the size selected by the user is appended to this command. With the transmission of the command herein, small-screen image data in the image format of the size selected by the user is generated at the disc player 300 or gaming device 200, and the small-screen data herein is transmitted via the bi-directional communication path (HEC).

The small-screen image data herein is supplied from the Ethernet interface 124 to the video/graphics processing circuit 111. With the video/graphics processing circuit 111, the small-screen image data from the disc player 300 or gaming device 200 is synthesized with the image data obtained with the MPEG decoder 110. Therefore, a two-screen display is performed on the display panel 113 wherein a small-screen image from the gaming device 200 or the disc player 300 has been inserted into the image from the disc player 300 or the gaming device 200 (see FIG. 5).

Also, when the user performs picture-in-picture display stopping operations in the state that the above-described two-screen display is being performed, with the CPU 121 the <request HEC small-screen transfer stop> command is transmitted to the disc player 300 or gaming device 200. With the command herein, generation and transmission of the small-image data is stopped with the disc player 300 or gaming device 200. Therefore, the small-screen image data is no longer supplied from the Ethernet interface 124 to the video/graphics processing circuit 111, and the two-screen display is stopped.

Also, when the user performs enlarging operations of the small screen in the state that the above-described two-screen display is being performed, with the CPU 121 the <request HEC small-screen transfer stop/enlarge> command is transmitted to the disc player 300 or gaming device 200. With the command herein, at the disc player 300 or gaming device 200, generation and transmission of the small-screen image data is stopped, and transmitting full-size image data and audio data from the HDMI transmission unit to the TMDS channel is started.

With the HDMI switcher 103, of the HDMI terminals 101 and 102, the HDMI terminal connected to the device on the side that the small-screen image has been displayed is connected to the HDMI receiving unit 104. Therefore, at the HDMI receiving unit 104, the image data and audio data from the device on the side that the small-screen image has been displayed is obtained.

The image data obtained with the HDMI receiving unit 104 is selected at the video/graphics processing circuit 111, and the image data herein is supplied to the panel driving circuit 112. Therefore, of the disc player 300 or gaming device 200, the full-size image of the device on the side that the small-screen image has been displayed is displayed on the display panel 113. Also, at this time, the audio data obtained with the HDMI receiving unit 104 is selected with the audio processing circuit 114, processing for D/A conversion and so forth is performed as to the audio data herein, and the data is supplied to the speaker 116 via the audio amplifying circuit 115. Therefore, audio of the device on the side that the small-screen image has been displayed is output.

### Configuration Example of Gaming Device

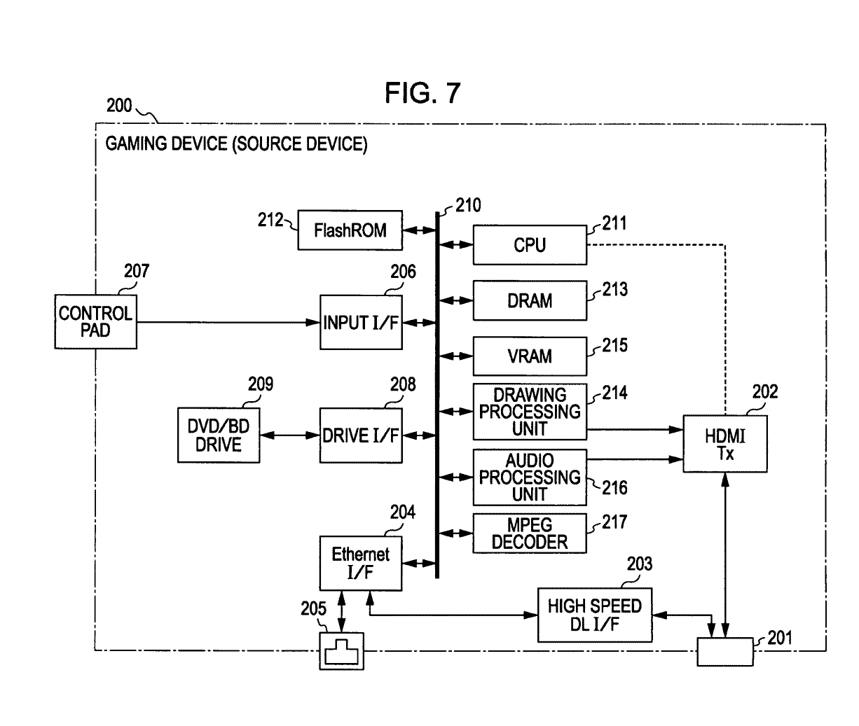

FIG. 7 shows a configuration example of the gaming device 200. The gaming device 200 has an HDMI terminal 201, HDMI transmitting unit (HDMITx) 202, high-speed data line interface (high-speed DL I/F) 203, Ethernet interface 204, and network terminal 205. Also, the gaming device 200 has an input interface 206, control pad 207, drive interface 208, and DVD/BD (Digital Versatile Disk/Blu-ray Disc) drive 209.

Also, the gaming device 200 has an internal bus 210, CPU 211, flash ROM 212, and DRAM 213. Also, the gaming device 200 has a drawing processing unit 214, VRAM (Video Random Access memory) 215, audio processing unit 216, and MPEG decoder 217.

The HDMI transmitting unit 202 transmits non-compressed (base band) image data and audio data in one direction to the television receiver 100 which his connected to the HDMI terminal 201, with communication according to HDMI standards. In this case, transmission is made with an HDMI TMDS channel, whereby the image and audio data is subjected to packing, and output from the HDMI transmitting unit 202 to the HDMI terminal 201. Details of the HDMI transmitting unit 202 will be described later.

The high-speed data line interface 203 is a bi-directional communication path (HEC) interface made up of a predetermined line (according to the present embodiment, a utility line and HPD line) of the HDMI cable connected to the HDMI terminal 201. The high-speed data line interface 203 is inserted between the Ethernet interface 204 and the HDMI terminal 201. Details of the high-speed data line interface 203 will be described later.

The CPU 211, flash ROM 212, DRAM 213, Ethernet interface 204, input interface 206, and drive interface 208 are connected to the internal bus 210. Also, the drawing processing unit 214, VRAM 215, audio processing unit 216, and MPEG decoder 217 are also connected to the internal bus 210. The DVD/BD drive 209 is connected to the internal bus 210 via the drive interface 208.

The DVD/BD drive 209 performs playing of the content such as movies that are recorded on recording media such as DVD, BD and the like, and playing of game software information recorded on the recording media herein, and so forth. In the case that the gaming device 200 is functioning as a playing device, the MPEG decoder 217 performs decoding processing as to compressed video data and audio data that has been played from the recording media such as the DVD and the like, and obtains non-compressed video data and audio data.

The CPU 211 controls the operations of the various parts of the gaming device 200. Also, the CPU 211 performs communication of the control information with the television receiver 100, through the HDMI/CEC network made up of a CEC line which is a control data line of the HDMI cable 401. The flash ROM 212 stores the control software and holds data. The DRAM 213 makes up the work area of the CPU 211. The CPU 211 loads the software and data read out from the flash ROM 212 to the DRAM 213 and starts the software, controls the various parts of the gaming device 200, and also performs communication of control information with the television receiver 100.

As described above, when the user performs display operations for picture-in-picture (small-screen display request), the CPU 121 of the television receiver 100, transmits a <confirm HEC small-screen capability> command to the gaming device 200 through the HDMI/CEC network. The CPU 121 receives the <confirm HEC small-screen capability> command herein. This command is a command to query the gaming device 200 as to whether or not there is capability to transmit small-screen image data in the image format that can be received by the television receiver 100. A code indicating the image format receivable by the television receiver 100 is appended to the command.

In response to the <confirm HEC small-screen capability> command, when the gaming device 200 has such capability, a <HEC small-screen capability response> command is transmitted to the television receiver 100 through the HDMI/CEC network. Of the image formats receivable by the television receiver 100, a code indicating the image format that can be transmitted with the gaming device 200 is appended to the command. On the other hand, when there is no such capability regarding the <confirm HEC small-screen capability>, a <Feature Abort> command is transmitted to the television receiver 100 through the HDMI/CEC network.

Also, as described above, when the user selects the display of the small-screen image from the gaming device 200, the CPU 121 of the television receiver 100 transmits a <request HEC small-screen transfer start> command to the gaming device 200 via the HDMI/CEC network. A code indicating the image format for the size selected by the user is appended to the command herein. The CPU 211 receives the <request HEC small-screen transfer start> command.

The CPU 211 performs scaling processing such as thinning processing as to the full-size image data (content playing image data or game image data), and generates small-screen image data in the image format corresponding to the appended code. The CPU 211 outputs the small-screen image data to the HDMI terminal 201 from the Ethernet interface 204 through the high speed data line interface 203, and transmits this to the television receiver 100 via the bi-directional communication path (HEC).

Also, as described above, when the user performs picture-in-picture display stopping operations (small-screen stopping request) at the time that the small-screen image from the gaming device 200 is displayed, the CPU 121 of the television receiver 100 transmits the <request HEC small-screen transfer stop> command to the gaming device 200. The CPU 211 receives the <request HEC small-screen transfer stop> command herein, and stops the generation and transmission of the small-screen image data.

Also, as described above, when the user performs enlarging operations of the small-screen image at the time that the small-screen image from the gaming device 200 is displayed, the CPU 121 of the television receiver 100 transmits the <request HEC small-screen transfer stop/enlarge> command to the gaming device 200. The CPU 211 receives the <request HEC small-screen transfer stop/enlarge> command herein, stops the generation and transmission of the small-screen image data, and starts to transmit the full-size image data and audio data from the HDMI transmitting unit 202 with the TMDS channel.

The control pad 207 makes up a user operating unit. The input interface 206 takes in the operating input signals from the control pad 207 to the internal bus 210. The drawing processing unit 214 has a drawing engine. In the case that the gaming device 200 functions as a gaming device, the drawing processing unit 214 dynamically creates game images according to user operations from the control pad 207, based on the game software information, and loads this to the VRAM 215.

In the case that the gaming device 200 functions as a gaming device, the audio processing unit 216 generates audio data to obtain game audio corresponding to the game images, according to user operations from the control pad 207, based on the game software information.

The operations of the gaming device 200 shown in FIG. 7 will be described briefly. The operations at the time of playing the content such as movies recorded on the recording media such as DVD, BD or the like will be described. The image data and audio data played on the DVD/BD drive 209 is subjected to decoding processing with the MPED decoder 217, and non-compressed image data and audio data is obtained. The image data and audio data herein is supplied to the HDMI transmitting unit 202, and transmitted from the HDMI terminal 201 to the television receiver 100, via the HDMI cable 401, with the HDMI TMDS channel.

Also, operations in the case of functioning as a gaming device will be described. At the drawing processing unit 214, based on the game software information, image data for displaying the game images is dynamically generated according to user operations from the control pad 207, and loaded to the VRAM 215. The image data is read out from the VRAM 215, and supplied to the HDMI transmitting unit 202.

Also, in this case, with the audio processing unit 216, audio data for obtaining game audio corresponding to the game image is generated according to user operations from the control pad 207, based on the game software information. The audio data herein is supplied to the HDMI transmitting unit 202. The image data and audio data of the game supplied to the HDMI transmitting unit 202 is transmitted from the HDMI terminal 201 to the television receiver 100 via the HDMI cable 401, with the HDMI TMDS channel.

Also, when the <confirm HEC small-screen capability> command is transmitted from the television receiver 100 through the HDMI/CEC network, this command is received by the CPU 211 through the HDMI transmitting unit 202. With the CPU 211, when there is capability to transmit small-screen image data in the image format receivable by the television receiver 100, an <HEC small-screen capability response> command is transmitted to the television receiver 100. On the other hand, when there is no capability with the CPU 211, a <Feature Abort> command is transmitted to the television receiver 100.

Also, when a <request HEC small-screen transfer start> command is transmitted from the television receiver 100 through the HDMI/CEC network, this command is received by the CPU 211 through the HDMI transmitting unit 202. Scaling processing is performed as to the full-size image data (content playing image data or gaming image data) with the CPU 211, and small-screen image data of the image format corresponding to the code which is appended to the <request HEC small-screen transfer start> command is generated.

The small-screen image data is output from the Ethernet interface 204 to the HDMI terminal 201 through the high-speed data line interface 203, and transmitted to the television receiver 100 via the bi-directional communication path (HEC). Thus, two-screen display wherein the small-screen image of the gaming device 200 is inserted in the large-screen image (internal tuner image or image from the disc player 300) is performed on the display panel 113 of the television receiver 100.

Also, when a <request HEC small-screen transfer stop> command is transmitted from the television receiver 100 through the HDMI/CEC network, this command is received by the CPU 211 through the HDMI transmitting unit 202. The generation and transmission of small-screen image data is stopped by the CPU 211. Therefore, the small-screen image of the gaming device 200 is no longer displayed, and the two-screen display is stopped at the television receiver 100.

Also, when the <request HEC small-screen transfer stop/enlarge> command is transmitted from the television receiver 100 through the HDMI/CEC network, this command is received by the CPU 211 through the HDMI transmitting unit 202. The generation and transmission of small-screen image data is stopped by the CPU 211, and full-size image data and audio data is transmitted from the HDMI transmitting unit 202 to the television receiver 100 with the TMDS channel. Thus, with the television receiver 100, the two-screen display wherein the small-screen image from the gaming device 200 is inserted in the large-screen image (internal tuner image or image from the disc player 300) is modified to a full-size display of the image from the gaming device 200. Also, at this time, audio from the gaming device 200 is output from the speaker 116.

### Configuration Example of Disc Player

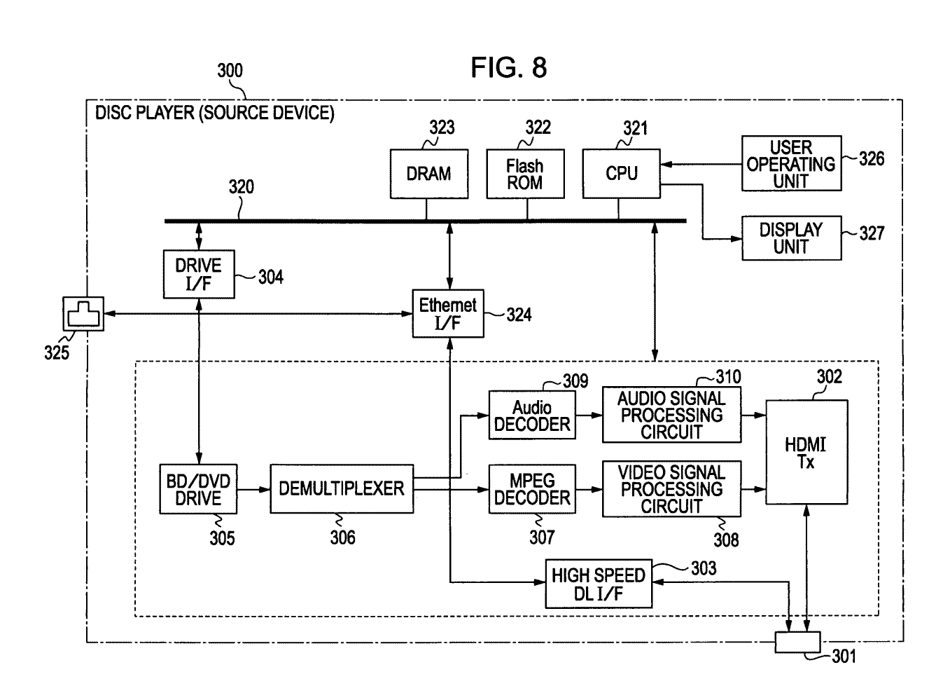

FIG. 8 shows a configuration example of the disc player 300. The disc player 300 herein has an HDMI terminal 301, HDMI transmitting unit (HDMITx) 302, high-speed data line interface (high-speed DL I/F) 303, drive interface 304, and BD/DVD drive 305. Also, the disc player 300 has a de-multiplexer 306, MPEG decoder 307, video signal processing circuit 308, audio decoder 309, and audio signal processing circuit 310.

Also, the disc player 300 has an internal bus 320, CPU 321, flash ROM 322, and DRAM 323. Also, the disc player 300 has an Ethernet interface 324, network terminal 325, user operating unit 326, and display unit 327.

The HDMI transmitting unit 302 transmits non-compressed (base band) image data and audio data in one direction to the television receiver 100 which is connected to the HDMI terminal 301, with communication according to HDMI standards. In this case, the data is transmitted with and HDMI TMDS channel, whereby the image and audio data is subjected to packing, and is output from the HDMI transmitting unit 302 to the HDMI terminal 301. Details of the HDMI transmitting unit 302 will be described later.

The high-speed data line interface 303 is a bi-directional communication path (HEC) interface made up of a predetermined line (utility line and HPD line according to the present embodiment) of an HDMI cable connected to the HDMI terminal 301. The high-speed data line interface 303 herein is inserted between the Ethernet interface 324 and HDMI terminal 301. Details of the high-speed data line interface 303 will be described later.

The CPU 321, flash ROM 322, DRAM 323, Ethernet interface 324, and drive interface 304 are connected to the internal bus 320. The CPU 321 controls the operations of the various parts of the disc player 300. Also, the CPU 321 performs communication of control information with the television receiver 100 through the HDMI/CEC network made up of a CEC line which is a control data line of the HDMI cable 402.

The flash ROM 322 stores the control software and holds data. The DRAM 323 makes up the work area of the CPU 321. The CPU 321 opens the software and data read out from the flash ROM 322 on the DRAM 323 and starts up the software, controls the various parts of the disc player 300, and also performs communication of control information with the television receiver 100.

A user operating unit 326 and display unit 327 are connected to the CPU 321. The user operating unit 326 and display unit 327 herein make up a user interface. With the user operating unit 326, the user can operate the operations of the disc player 300. The user operating unit 326 is made up of keys, buttons, dials, remote control transmission/reception devices and so forth disposed on an unshown casing of the disc player 300. The display unit 327 displays the operating state of the disc player 300, the operating state of the user, and so forth, and is made up of an LCD (Liquid Crystal Display) or the like.

As described above, when the user performs display operations for picture-in-picture (small-screen display request), the CPU 121 of the television receiver 100 transmits a <confirm HEC small-screen capability> command to the disc player 300 through the HDMI/CEC network. The CPU 321 receives the <confirm HEC small-screen capability> command herein. As described above, this command is a command to query the disc player 300 as to whether or not there is capability to transmit small-screen image data in the image format that can be received by the television receiver 100. A code indicating the image format receivable by the television receiver 100 is appended to the command.

In response to the <confirm HEC small-screen capability> command, when the disc player 300 has such capability, the CPU 321 transmits a <HEC small-screen capability response> command to the television receiver 100 through the HDMI/CEC network. Of the image formats receivable by the television receiver 100, a code indicating the image format that can be transmitted with the disc player 300 is appended to the command. On the other hand, when there is no such capability as to the <confirm HEC small-screen capability> command, the CPU 321 transmits a <Feature Abort> command to the television receiver 100 through the HDMI/CEC network.

Also, as described above, when the user selects the display of the small-screen image from the disc player 300, the CPU 121 of the television receiver 100 transmits a <request HEC small-screen transfer start> command through the HDMI/CEC network. A code indicating the image format for the size selected by the user is appended to the command herein. The CPU 321 receives the <request HEC small-screen transfer start> command.

The CPU 321 performs scaling processing such as thinning processing as to the full-size image data (content playing image data), and generates small-screen image data in the image format corresponding to the appended code. The CPU 321 outputs the small-screen image data to the HDMI terminal 301 from the Ethernet interface 324 through the high speed data line interface 303, and transmits this to the television receiver 100 via the bi-directional communication path (HEC).

Also, as described above, when the user performs picture-in-picture display stopping operations at the time that the small-screen image from the disc player 300 is displayed, the CPU 121 of the television receiver 100 transmits the <request HEC small-screen transfer stop> command to the disc player 300. The CPU 321 receives the <request HEC small-screen transfer stop> command herein, and stops the generation and transmission of the small-screen image data.

Also, as described above, when the user performs enlarging operations of the small-screen image at the time that the small-screen image from the disc player 300 is displayed, the CPU 121 of the television receiver 100 transmits the <request HEC small-screen transfer stop/enlarge> command to the disc player 300. The CPU 321 receives the <request HEC small-screen transfer stop/enlarge> command herein, stops the generation and transmission of the small-screen image data, and starts to transmit the full-size image data and audio data from the HDMI transmitting unit 302 with the TMDS channel.

The BD/DVD drive 305 plays content data from a BD and DVD (unshown) as disc-type recording media. The BD/DVD drive 305 is connected to the internal bus 320 via the drive interface 304. The de-multiplexer 306 separates elementary streams such as video, audio, and so forth from the playing data of the BD/DVD drive 305. The MPEG decoder 307 performs decoding processing as to the video elementary streams separated with the de-multiplexer 306, and obtains non-compressed image data.

The image signal processing circuit 308 performs scaling processing (resolution conversion processing), superimposing processing of graphics data, and so forth, as appropriate, as to the image data obtained with the MPEG decoder 307, and supplies this to the HDMI transmitting unit 302.

The audio decoder 309 performs decoding processing as to the audio elementary streams separated with the de-multiplexer 306, and obtains non-compressed audio data. The audio signal processing circuit 310 performs audio quality adjustment processing and so forth, as appropriate, as to the audio data obtained with the audio decoder 309, and supplies this to the HDMI transmitting unit 302.

The operations of the disc player 300 shown in FIG. 8 will be described briefly. The playing data of the BD/DVD drive 305 is supplied to the de-multiplexer 306, and separated into elementary streams such as video and audio. The video elementary streams separated with the de-multiplexer 306 are supplied to the MPEG decoder 307 and decoded, whereby non-compressed image data is obtained. Also, the audio elementary streams separated with the de-multiplexer 306 are supplied to the audio decoder 309 and decoded, whereby non-compressed audio data is obtained.

The image data obtained with the MPEG decoder 307 are supplied to the HDMI transmitting unit 302 via the video signal processing circuit 308. Also, the audio data obtained with the audio decoder 309 is supplied to the HDMI transmitting unit 302 via the audio signal processing circuit 310. The image and audio data herein is transmitted to the television receiver 100 from the HDMI terminal 301 to the via the HDMI cable 402 with the HDMI TMDS channel.

Also, when the <confirm HEC small-screen capability> command is transmitted from the television receiver 100 through the HDMI/CEC network, the command herein is received with the CPU 321 through the HDMI transmitting unit 302. When there is the capability to transmit small-screen image data in the image format that can be received by the television receiver 100, the <HEC small-screen capability response> command is transmitted to the television receiver 100 with the CPU 321. On the other hand, where there is no capability, a <Feature Abort> command is transmitted to the television receiver 100 with the CPU 321.

Also, when the <request HEC small-screen transfer start> command is transmitted from the television receiver 100 through the HDMI/CEC network, the command herein is received with the CPU 321 through the HDMI transmitting unit 302. Scaling processing such as thinning processing is performed as to the full-size image data (content playing image data) with the CPU 321, and small-screen image data in the image format corresponding to the code appended to the <request HEC small-screen transfer start> command is generated.

The small-screen image data herein is output to the HDMI terminal 301 from the Ethernet interface 324 through the high-speed data line interface 303, and is transmitted to the television receiver 100 via the bi-directional communication path (HEC). Therefore, a two-screen display is performed on the display panel 113 of the television receiver 100 wherein a small-screen image from the disc player 300 has been inserted into the large-screen image (internal tuner image or the gaming device 200).

Also, when the <request HEC small-screen transfer stop> command is transmitted from the television receiver 100 through the HDMI/CEC network, the command herein is received with the CPU 321 through the HDMI transmitting unit 302. The generation and transmission of small-screen image data is stopped by the CPU 321. Therefore, with the television receiver, the small-screen images from the disc player 300 are no longer displayed, and the two-screen display is stopped.

Also, when the <request HEC small-screen transfer stop/enlarge> command is transmitted from the television receiver 100 through the HDMI/CEC network, the command herein is received with the CPU 321 through the HDMI transmitting unit 302. The generation and transmission of small-screen image data is stopped by the CPU 321, and the full-size image data and audio data is transmitted to the television receiver 100 from the HDMI transmitting unit 302 with the TMDS channel. Thus, with the television receiver 100, the two-screen display wherein the small-screen image from the disc player 300 is inserted in the large-screen image (internal tuner image or image from the gaming device 200) is modified to a full-size display of the image from the disc player 300. Also, at this time, audio from the disc player 300 is output from the speaker 116.

### Configuration Example of HDMI Transmitting Unit and HDMI Receiving Unit

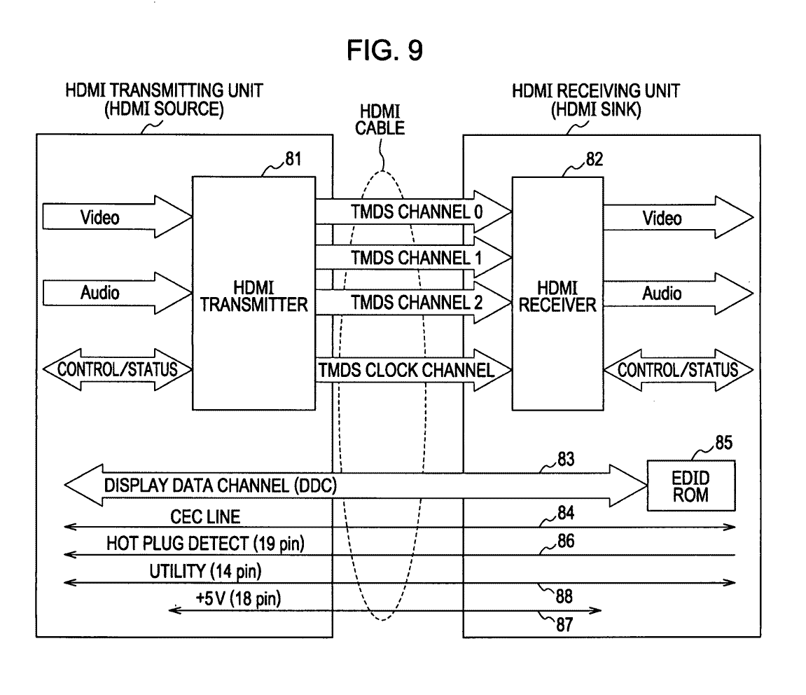

FIG. 9 shows a configuration example of HDMI transmitting units (HDMI transmitting unit 202 of the gaming device 200 and HDMI transmitting unit 302 of the disc player 300) and an HDMI receiving unit (HDMI receiving unit 104 of the television receiver 100) of the AV system 10 in FIG. 1.

The HDMI transmitting unit (HDMI source) transmits a differential signal corresponding to non-compressed pixel data of the image of one screen worth, in one direction, to the HDMI receiving unit (HDMI sink) with multiple channels in a valid image segment (hereafter also called active video segment, as appropriate). A valid image segment is a segment wherein a horizontal blanking segment and vertical blanking segment are removed from a segment that is from one vertical synchronized signal to the next vertical synchronized signal. Also, the HDMI transmitting unit transmits differential signals corresponding to audio data, control data, and other auxiliary data and so forth, accessory to images at least, in one direction, to the HDMI receiving unit with multiple channels in a horizontal blanking segment or vertical blanking segment.

A transfer channel of the HDMI system made up of an HDMI transmitting unit and HDMI receiving unit has the following transfer channels. That is to say, there are three TMDS channels #0 through #2, serving as transfer channel to synchronize pixel data and audio data to a pixel clock and serially transfer in one direction, from the HDMI transmitting unit to the HDMI receiving unit. Also, there is a TMDS clock channel serving as a transfer channel to transfer a pixel clock.

The HDMI transmitting unit has an HDMI transmitter 81. The transmitter 81 converts pixels data of a non-compressed image into corresponding differential signals, for example, and transfers these serially in one direction to the HDMI receiving unit 202 which is connected via the HDMI cable, with three TMDS channels #0, #1, and #2, which are multiple channels.

Also, the transmitter 81 converts audio data that is associated with a non-compressed image, and further, control data to be used and other auxiliary data and so forth into corresponding differential signals, and transfers these serially in one direction to the HDMI receiving unit with the three TMDS channels #0, #1, and #2.

Further, the transmitter 81 transmits the pixel clock synchronized with the pixel data which is transmitted with the three TMDS channels #0, #1, and #2 to the HDMI receiving unit that is connected via the HDMI cable, with the TMDS clock channel. Now, with one TMDS channel #i (i=0, 1, 2), 10 bits of pixel data is transmitted in the space of one clock of the pixel clock.

In an active video segment, the HDMI receiving unit receives the differential signals corresponding to the pixel data which is transmitted in one direction from the HDMI transmitting unit with multiple channels. Also, in a horizontal blanking segment or a vertical blanking segment, the HDMI receiving unit receives the differential signals corresponding to the audio data and control data which is transmitted in one direction from the HDMI transmitting unit with multiple channels.

That is to say, the HDMI receiving unit has an HDMI receiver 82. The HDMI receiver 82 receives the differential signals corresponding to pixel data and differential signals corresponding to the audio data and control data, which are transmitted in one direction from the HDMI transmitting unit with the TMDS channels #0, #1, and #2. In this case, the differential signals are synchronized to the pixel clock which is transmitted from the HDMI transmitting unit with a TMDS clock channel, and are received.

The transfer channel of the HDMI system has a transfer channel called a DDC (Display Data Channel) 83 and CEC line 84, as well as the above-described TMDS channels #0 through #2 and the TMDS clock channel. The DDC 83 is made up of two unshown signal lines included in the HDMI cable. The DDC 83 is used to read out E-EDID (Enhanced Extended Display Identification Data) from the HDMI receiving unit.

That is to say, the HDMI receiving unit has an EDID ROM (Read Only Memory) 85 which stores the E-EDID which is capability information relating to the capability of itself (Configuration/capability), as well as the HDMI receiver. The HDMI transmitting unit reads out the E-EDID from the HDMI receiving unit that is connected via the HDMI cable, according to requests from the CPU 211 (see FIG. 7), via the DDC 83. The HDMI transmitting unit sends the read out E-EDID to the CPU 211. The CPU 211 stores the E-EDID in the flash ROM 212 or DRAM 213.

The CEC line 84 is made up of one unshown signal line included in the HDMI cable, and is used to perform bi-directional communication of control data between the HDMI transmitting unit and HDMI receiving unit. The CEC line 84 herein makes up a control data line.

Also, a line (HPD line) 86 that is connected to a pin called HPD (Hot Plug Detect) is included in the HDMI cable. The source device can use the line 86 to detect connections of the sink device. Note that in FIG. 9, an arrow is shown on the HPD line 86 to indicate one direction from the sink to the source. However, the HPD line 86 herein is also used as a HEAC-line making up a bi-directional communication path, and in such a case this becomes a bi-directional line. Also, a line (power line) 87 used to supply power from the source device to the sink device is included in the HDMI cable. Further, a utility line 88 is included in the HDMI cable.

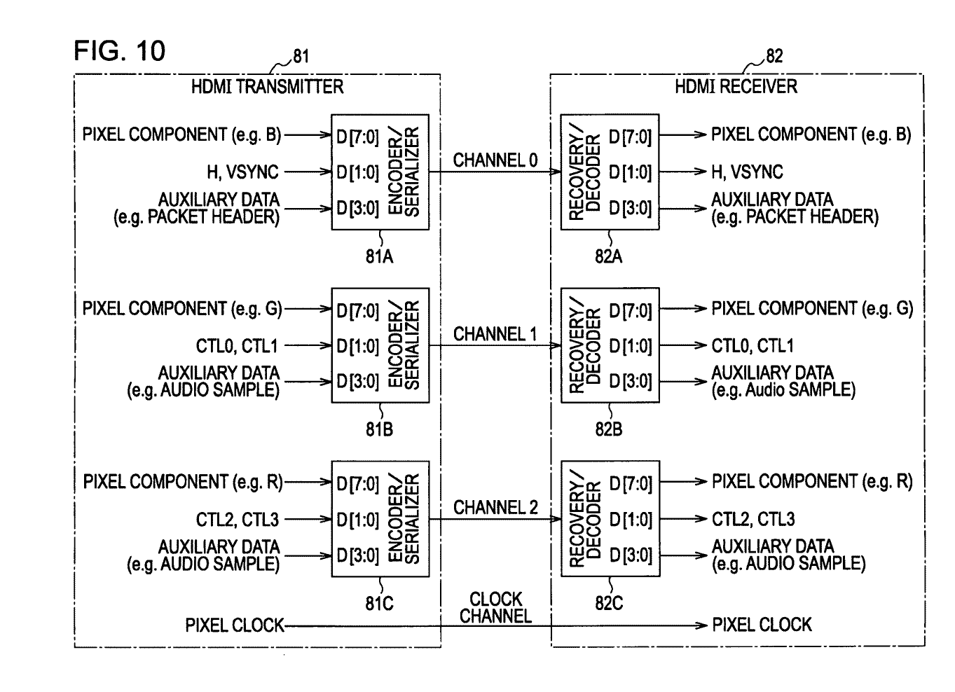

FIG. 10 shows a configuration example of the HDMI transmitter 81 and HDMI receiver 82 in FIG. 9. The HDMI transmitter 81 has three encoders/serializers 81A, 81B, and 81C which correspond to three TMDS channels #0, #1, and #2, respectively. Each of the encoders/serializers 81A, 81B, and 81C encode the image data, auxiliary data, and control data supplied thereto, converts the data from parallel data into serial data, and transmits this with differential signals. Now, in the case that the image data has three components of R, G, B, for example, the B-component is supplied to the encoder/serializer 81A, the G-component is supplied to the encoder/serializer 81B, and the R-component is supplied to the encoder/serializer 81C.

Also, the auxiliary data has audio data and control packets, for example, and the control packets are supplied to the encoder/serializer 81A, and the audio data supplied to the encoders/serializers 81B and 81C, for example. Further, control data includes a one-bit vertical synchronized signal (VSYNC), a one-bit horizontal synchronized signal (HSYNC), and control bits CTL0, CTL1, CTL2, and CTL 3 that are one-bit each. The vertical synchronized signal and horizontal synchronized signal are supplied to the encoder/serializer 81A. The control bits CTL0 and CTL1 are supplied to the encoder/serializer 81B, and the control bits CTL2 and CTL3 are supplied to the encoder/serializer 81C.

The encoder/serializer 81A transmits the B-components of the image data supplied thereto, the vertical synchronized signal and horizontal synchronized signal, and the auxiliary data, with time-division. That is to say, the encoder/serializer 81A causes the B-components of the image data supplied thereto to be parallel data in 8-bit units which are fixed-bit units. Further, the encoder/serializer 81A encodes the parallel data thereof, converts this to serial data, and transmits this to the TMDS channel #0.

Also, the encoder/serializer 81A encodes the two-bit parallel data of the vertical synchronized signal and horizontal synchronized signal supplied thereto, converts this into serial data, and transmits this to the TMDS channel #0. Further, the encoder/serializer 81A causes the auxiliary data supplied thereto to be parallel data in 4-bit units. The encoder/serializer 81A encodes the parallel data thereof, converts this to serial data, and transmits this to the TMDS channel #0.

The encoder/serializer 81B transmits the G-components of the image data supplied thereto, the control bits CTL0 and CTL1, and the auxiliary data, with time-division. That is to say, the encoder/serializer 81B causes the G-components of the image data supplied thereto to be parallel data in 8-bit units which are fixed-bit units. Further, the encoder/serializer 81B encodes the parallel data thereof, converts this to serial data, and transmits this to the TMDS channel #1.

Also, the encoder/serializer 81B encodes the two-bit parallel data of the control bits CTL 0 and CTL 1 supplied thereto, converts this into serial data, and transmits this to the TMDS channel #1. Further, the encoder/serializer 81B causes the auxiliary data supplied thereto to be parallel data in 4-bit units. The encoder/serializer 81B encodes the parallel data thereof, converts this to serial data, and transmits this to the TMDS channel #1.

The encoder/serializer 81C transmits the R-components of the image data supplied thereto, the control bits CTL 2 and CTL 3, and the auxiliary data, with time-division. That is to say, the encoder/serializer 81C causes the R-components of the image data supplied thereto to be parallel data in 8-bit units which are fixed-bit units. Further, the encoder/serializer 81C encodes the parallel data thereof, converts this to serial data, and transmits this to the TMDS channel #2.

Also, the encoder/serializer 81C encodes the two-bit parallel data of the control bits CTL 2 and CTL 3 supplied thereto, converts this into serial data, and transmits this to the TMDS channel #2. Further, the encoder/serializer 81C causes the auxiliary data supplied thereto to be parallel data in 4-bit units. The encoder/serializer 81C encodes the parallel data thereof, converts this to serial data, and transmits this to the TMDS channel #2.

The HDMI receiver 82 has three recovery/decoders 82A, 82B, and 82C that correspond to the three TMDS channels #0, #1, and #2 respectively. Each of the recovery/decoders 82A, 82B, and 82C receive the image data, auxiliary data, and control data transmitted by differential signals with the TMDS channels #0, #1, and #2. Further, each of the recovery/decoders 82A, 82B, and 82C convert the image data, auxiliary data, and control data from serial data into parallel data, and further decode and output this.

That is to say, the recovery/decoder 82A receives the B-components of the image data, the vertical synchronized signal and horizontal synchronized signal, and auxiliary data transmitted by the differential signals with the TMDS channel #0. The recovery/decoder 82A converts the B-components of the image data, the vertical synchronized signal and horizontal synchronized signal, and auxiliary data from serial data into parallel data, and decodes and outputs this.

The recovery/decoder 82B receives the G-components of the image data, the control bits CTL 0 and CTL 1, and auxiliary data transmitted by the differential signals with the TMDS channel #1. The recovery/decoder 82B converts the G-components of the image data, the control bits CTL 0 and CTL 1, and auxiliary data from serial data into parallel data, and decodes and outputs this.

The recovery/decoder 82C receives the R-components of the image data, the control bits CTL 2 and CTL 3, and auxiliary data transmitted by the differential signals with the TMDS channel #2. The recovery/decoder 82C converts the R-components of the image data, the control bits CTL 2 and CTL 3, and auxiliary data from serial data into parallel data, and decodes and outputs this.

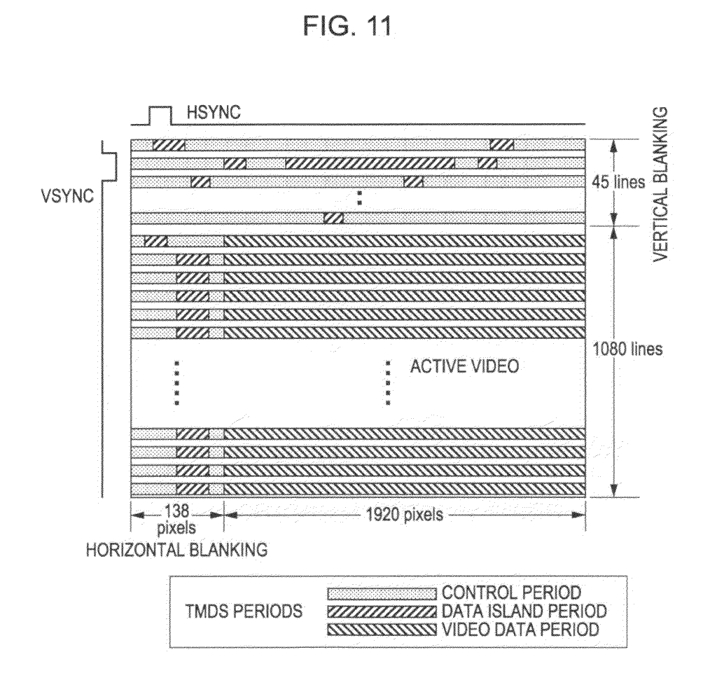

FIG. 11 shows a configuration example of the TMDS transfer data. FIG. 11 herein shows various types of transfer data periods in the case that image data having a horizontal×vertical size of 1920 pixels×1080 lines is transferred with the TMDS channels #0, #1, and #2.

There are three types of periods in a Video Fired wherein transfer data is transferred by the three HDMI TMDS channels #0, #1, and #2, according to the type of transfer data. The three types of periods are a Video Data period, Data Island period, and Control period.

The video field period is a period from the active edge of a certain vertical synchronized signal to the active edge of the next vertical synchronized signal. The video field period can be divided into horizontal blanking, vertical blanking, and active video periods. The active video period is a period wherein the horizontal blanking and vertical blanking are removed from the video field period.

The video data period can be assigned to an active video period. In this video data period, 1920 pixels×1080 lines worth of Active pixel data which makes up one screen worth of non-compressed image data is transferred.

The data island period and control periods are assigned to the horizontal blanking and vertical blanking. In the data island period and control period herein, auxiliary data is transferred. That is to say, the data island period is assigned to a portion of the horizontal blanking period and vertical blanking control period. In the data island period, of the auxiliary data, data which is not related to control, i.e. packets of audio data or the like is transferred.

The control period is assigned to other portions of the horizontal blanking and vertical blanking. In the control period herein, of the auxiliary data, data which is related to control, i.e. the horizontal synchronizing signals and vertical synchronizing signals, control packets or the like are transferred.

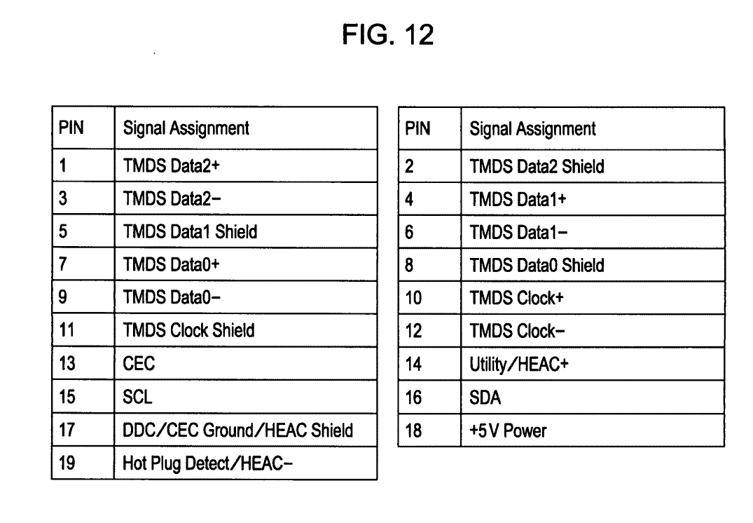

FIG. 12 shows an example of an HDMI terminal pin array. The pin array shown in FIG. 12 is called type-A. TMDS Data #i+ and TMDS Data #i−, which are differential signals of the TMDS channel #i, are transferred with two lines. The two lines herein are connected to pins to which the TMDS Data #i+ is assigned (pins having a pin number of 1, 4, 7), and pins to which the TMDS Data #i− is assigned (pins having a pin number of 3, 6, 9).

Also, the CEC line 84 that transfers the CEC signal which is control data is connected to a pin having a pin number of 13, and the pin having a pin number of 14 is an empty (Reserved) pin. Also, the line that transfers an SDA (Serial Data) signal such as E-EDID is connected to a pin having a pin number of 16. The line that transfers the SCL (Serial Clock) signal, which is a clock signal used for synchronization at time of transmitting/receiving the SDA signal, is connected to a pin having a pin number of 15. The above-described DDC 83 is made up of a line that transfers the SDA signal and a line that transfers the SCL signal.

Also, the HPD line 86 for the source device to detect a connection of the sink device as described above is connected to a pin having a pin number of 19. Also, the line for supplying power as described above is connected to a pin having a pin number of 18.

### Configuration Example of High Speed Data Line Interface

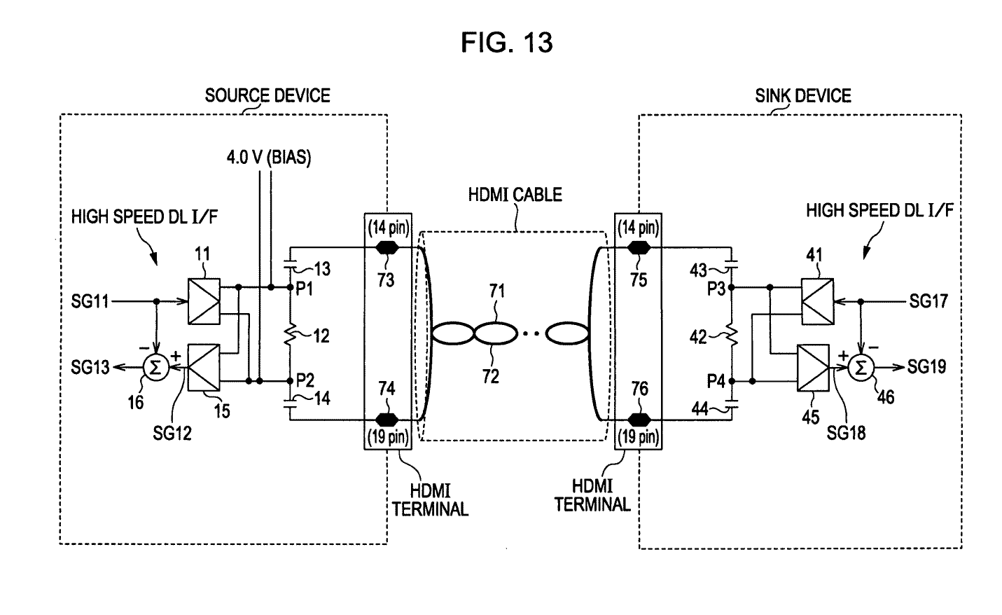

FIG. 13 shows a configuration example of the high speed data line interface of the source device and sink device. The high speed data line interface herein makes up a communication unit to perform LAN (Local Area Network) communication. The communication unit performs communication using the bi-directional communication path (HEC) made up of one pair of differential lines, of the multiple lines making up the HDMI cable. According to the present embodiment, a pair of differential lines is made up of a utility line (HEAC+line) corresponding to a reserved pin (pin 14) and an HPD line (HEAC−line) corresponding to an HPD pin (pin 19).

The source device has a LAN signal transmission circuit 11, end terminal resistor 12, AC coupling capacitors 13 and 14, LAN signal receiving circuit 15, and subtracting circuit 16, making up a high-speed data line interface (high-speed DL I/F). Between the pin 14 and pin 19 of the HDMI terminal, a direct circuit of the AC coupling capacitor 13, end terminal resistor 12, and AC coupling capacitor 14 is connected. A bias voltage (4.0V) is provided to a mutual connect point P1 for the AC coupling capacitor 13 and end terminal resistor 12, and to a mutual connect point P2 for the AC coupling capacitor 14 and the end terminal resistor 12.

The mutual connect point P1 for the AC coupling capacitor 13 and end terminal resistor 12 is connected to the positive output side of the LAN signal transmitting circuit 11, while also being connected to the positive input side of the LAN signal receiving circuit 15. Also, the mutual connect point P2 for the AC coupling capacitor 14 and the end terminal resistor 12 is connected to the negative output side of the LAN signal transmitting circuit 11, while also being connected to the negative input side of the LAN signal receiving circuit 15. A transmission signal (transmission data) SG 11 is supplied to the input side of the LAN signal transmitting circuit 11.

Also, an output signal SG 12 of the LAN signal receiving circuit 15 is supplied to the positive side terminal of the subtracting circuit 16, and a transmitting signal (transmission data) SG 11 is supplied to the negative side terminal of the subtracting circuit 16. With the subtracting circuit 16 herein, the transmission signal SG 11 is subtracted from the output signal SG 12 of the LAN signal receiving circuit 15, and the receiving signal (reception data) SG 13 is obtained.

The sink device has a LAN signal transmitting circuit 41, end terminal resistor 42, AC coupling capacitors and 44, LAN signal receiving circuit 45, and subtracting circuit 46, making up a high-speed data line interface (high-speed DL I/F). Between the pin 14 and pin 19 of the HDMI terminal, a direct circuit of the AC coupling capacitor 43, end terminal resistor 42, and AC coupling capacitor 44 is connected.

A mutual connect point P3 for the AC coupling capacitor 43 and the end terminal resistor 42 is connected to the positive output side of the LAN signal transmitting circuit 41, while also being connected to the positive input side of the LAN signal receiving circuit 45. Also, a mutual connect point P4 for the AC coupling capacitor 44 and the end terminal resistor 42 is connected to the negative output side of the LAN signal transmitting circuit 41, while also being connected to the negative input side of the LAN signal receiving circuit 45. A transmission signal (transmission data) SG 17 is supplied to the input side of the LAN signal transmitting circuit 41.

Also, an output signal SG 18 of the LAN signal receiving circuit 45 is supplied to the positive side terminal of the subtracting circuit 46, and a transmission signal SG 17 is supplied to the negative side terminal of the subtracting circuit 46. With the subtracting circuit 46, the transmission signal SG 17 is subtracted from the output signal SG 18 of the LAN signal receiving circuit 45, and the reception signal (reception data) SG 19 is obtained.

The utility line 71 and HPD line 72 included in the HDMI cable makes up a differential twist pair. The source side terminal 73 of the utility line 71 is connected to the 14 pin of the source device HDMI terminal, and the sink side terminal 75 of the utility line 71 is connected to the pin 14 of the sink device HDMI terminal. Also, the source side terminal 74 of the HPD line 72 is connected to the pin 19 of the source device HDMI terminal, and the sink side terminal 76 of the HPD line 72 is connected to the pin 19 of the sink device HDMI terminal.

Next, operations of the LAN communication by high speed data line interface which is configured as described above will be described.

With the source device, the transmission signal (transmission data) SG 11 is supplied to the input side of the LAN signal transmission circuit 11, and differential signals (positive output signal, negative output signal) corresponding to the transmission signal SG 11 from the LAN signal transmission circuit 11 is output. The differential signal output from the LAN signal transmission circuit 11 is supplied to the connecting points P1 and P2, and transmitted to the sink device through a pair of lines (utility line 71, HPD line 72) of the HDMI cable.

Also, with the sink device, the transmission signal (transmission data) SG 17 is supplied to the input side of the LAN signal transmission circuit 41, and differential signals (positive output signal, negative output signal) corresponding to the transmission signal SG 17 from the LAN signal transmission circuit 41 is output. The differential signal output from the LAN signal transmission circuit 41 is supplied to the connecting points P3 and P4, and transmitted to the source device through a pair of lines (utility line 71, HPD line 72) of the HDMI cable.

Also, with the source device, the input side of the LAN signal receiving circuit 15 is connected to the connecting points P1 and P2. Therefore, an added signal, of a transmission signal corresponding to the differential signal (current signal) output from the LAN signal transmitting circuit 11 and a reception signal corresponding to the differential signal transmitted from the sink device as described above, is obtained as the output signal SG 12 of the LAN signal receiving circuit 15. In the subtracting circuit 16, the transmission signal SG 11 is subtracted from the output signal SG 12 of the LAN signal receiving circuit 15. Therefore, the output signal SG 13 of the subtracting circuit 16 corresponds to the transmission signal (transmission data) SG 17 of the sink device.

Also, with the sink device, the input side of the LAN signal receiving circuit 45 is connected to the connecting points P3 and P4. Therefore, an added signal, of a transmission signal corresponding to the differential signal (current signal) output from the LAN signal transmitting circuit 41 and a reception signal corresponding to the differential signal transmitted from the sink device as described above, is obtained as the output signal SG 18 of the LAN signal receiving circuit 45. In the subtracting circuit 46, the transmission signal SG 17 is subtracted from the output signal SG 18 of the LAN signal receiving circuit 45. Therefore, the output signal SG 19 of the subtracting circuit 46 corresponds to the transmission signal (transmission data) SG 11 of the source device.

Thus, according to the configuration example shown in FIG. 13, bi-directional LAN communication can be performed between the high-speed data line interface of the source device and the high-speed data line interface of the sink device.

### Sequence Example of 2-Screen Display

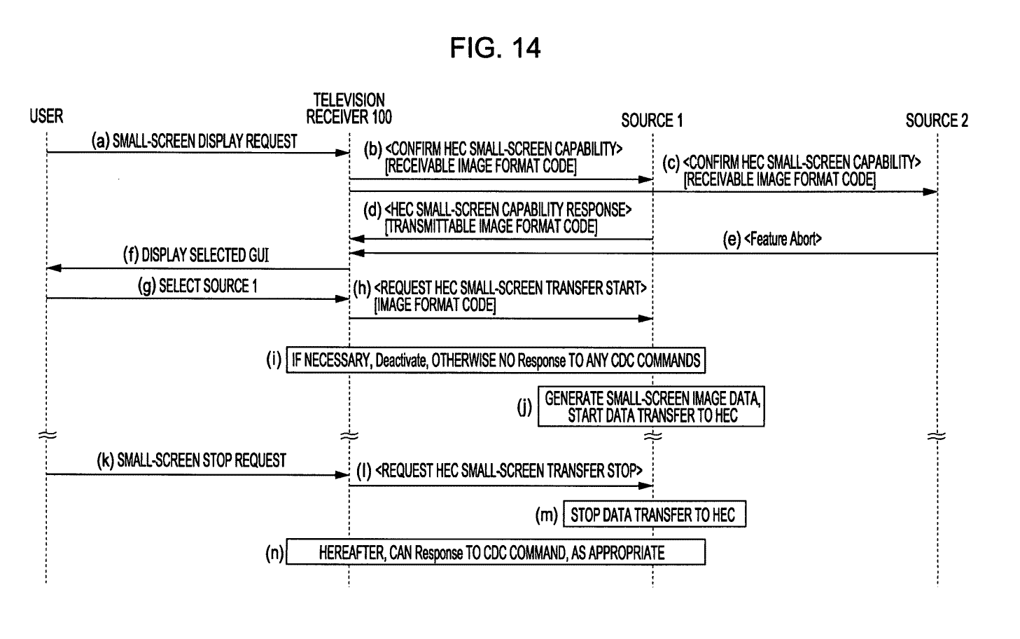

The sequence diagram in FIG. 14 shows a sequence example of a two-screen display according to the AV system 10 in FIG. 1. Note that the gaming device 200 and disc player 300 which are source devices will be generalized and described as source 1 and source 2.

(a) When the user performs picture-in-picture display operations (small-screen display request), (b)/(c) the CPU 121 of the television receiver 100 transmits the <confirm HEC small-screen capability> command to the source 1 and source 2. A code indicating the image format receivable by the television receiver 100 is appended to the command herein. Now let us say that the source 1 has the capability to transmit the small-screen image data of the image format receivable by the television receiver 100 through the bi-directional communication path (HEC), and source 2 does not have such capability.

(d) The CPU of the source 1 transmits the <HEC small-screen capability response> command to the television receiver 100. A code indicating the image format transmittable by the source 1, of the image formats receivable by the television receiver 100, is appended to the command herein. (e) On the other hand, the CPU of the source 2 transmits the <Feature Abort> command to the television receiver 100, and announces that there is not the capability to transmit the small-screen image data.

(f) The CPU of the television receiver 100 displays a GUI screen for selecting the small-screen image and the size thereof on the large-screen image, based on the <HEC small-screen capability response> command from the source 1 and the <Feature Abort> command from the source 2. (g) The user selects the size of the source 1 with the GUI screen, and when the display of the small-screen image thereof is selected, (h) the CPU 121 of the television receiver 100 transmits the <request HEC small-screen transfer start> command to the source 1. A code indicating the image format of the size selected by the user is appended to the command herein.

Note that in the case there is only one choice, i.e. there is one choice of small-screen images, and the size thereof is only one choice, or in the case that a desired device has been specified beforehand and so forth, the display of the GUI screen may become irrelevant.

Two devices to perform transmission/reception of the small-screen image data through the bi-directional communication path (HEC) are independent from the HDMI HEC network, whereby all HEC data transfer bands have to be secured for transfer of small-screen image data. In the sequence example shown in FIG. 14, the two devices performing transmission/reception of the small-screen image data are the television receiver 100 and source 1.

In the case that the two devices performing transmission/reception of the small-screen image data are built in to some network, i.e. in the case that the HEC has been activated, this has to be separated from the network. Therefore, for example, the devices to transmit the small-screen image data use the HDMI CDC (Capability Discovery Channel) command to request deactivating as to the activator of the network.

### CDC Data

CDC data will be described briefly. The CDC data herein is communicated between various devices making up the HDMI/CEC network through the CEC line, similar to the CEC data. First, CEC data will be described, after which CDC data will be described.

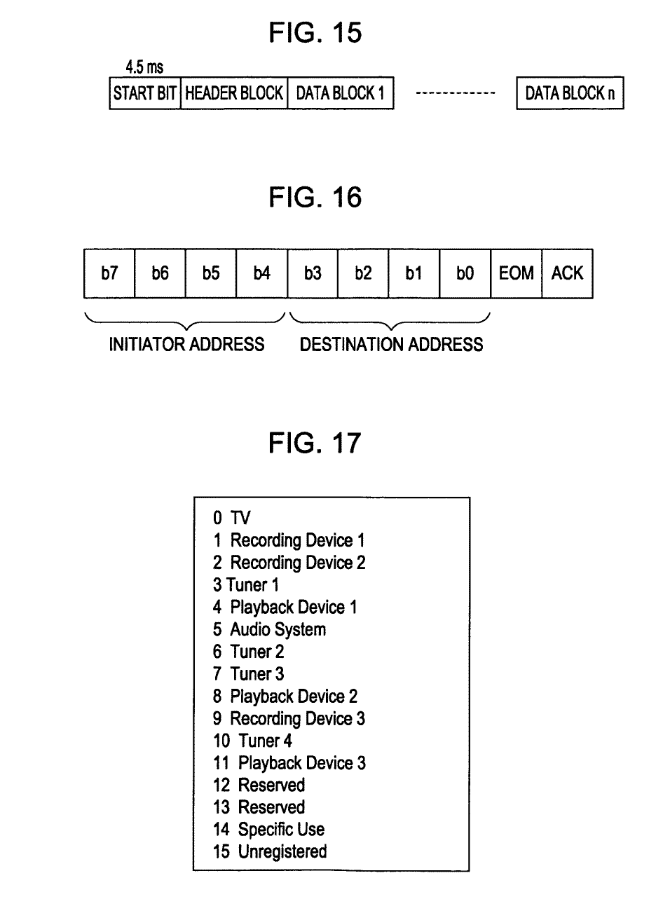

FIG. 15 shows a configuration of CEC data transferred with the CEC line. One block made up of 10-bit data is transferred with the CEC line in 4.5 milliseconds. A starting bit is positioned at the beginning, and a header block is positioned following this. Following the header block, an optional number (n) of data blocks including data that is actually to be transferred are positioned. The data (information) to be actually transferred is included in the data block.

FIG. 16 is a diagram showing a configuration example of a header block. A Logical Address of the transmission source (Initiator) and a Logical Address of the Destination are positioned in the header block. Each Logical Address is set according to the type of the various devices.

FIG. 17 shows Logical Addresses that are set according to type of the various devices. As shown in FIG. 17, sixteen types of address values, from “0” to “15” are set for each of the device types. A corresponding address value is positioned in four bits in the Logical Address of the transmission source (Initiator) and the Destination making up the header block in FIG. 16.

CDC data will be described. While the physical layer of the CDC is the same as the CEC, the logical layer is defined as differing from the CEC. The configuration of the CDC data is not shown, but is of a similar configuration as the CEC data configuration shown in FIG. 15, wherein a starting bit is positioned at the beginning, and a header block follows this. Following the header block, an optional number (n) of data blocks including data (information) to be actually transferred is positioned following the header block.

The configuration of the header block of the CDC data is unshown, but is similar in configuration to the header block of the CEC data shown in FIG. 16. However, “15” is constantly used for the Logical Address of the transmission source (Initiator) and the Logical Address of the Destination making up the header block, regardless of the type of device. That is to say, the transmission source (Initiator) is considered to be unknown (Unregistered), and the Destination is considered Broadcast.

Thus, in transferring the CDC data, “15” is used for the Logical Addresses of both the transmission sources and destination positioned in the header block, whereby the logical address of each device does not have to be obtained. A message by CDC data (CDC message) is a broadcast message with an unknown transmission source, and which device has addressed the message to which device is not known.

Thus, for a CDC message, in order to identify a physical connecting path, a Physical Address of the transmission source (Initiator) and Destination are to be included in the message positioned in the data block. That is to say, in transmitting the CDC message, a physical address is used and a logical address is not used.

The device transmitting the above-described small-screen image data transmits the CDC data, wherein a <CDC_HEC_Request Deactivation> command message is positioned in the data block, to the CEC line. Thus, the device transmitting the small-screen image data performs a deactivate request as to the activator of the network.

The command message herein includes parameters such as [Physical Address of Activator], [Physical Address of Terminating Devices 1], and [Physical Address of Terminating Devices 2]. [Physical Address of Activator] is a physical address of the activator. [Physical Address of Terminating Devices 1] is a physical address of a device at one end of a route that is to be released. Also, [Physical Address of Terminating Devices 2] is a physical address of a device at the other end of a route that is to be released.

The activator receiving the command message herein releases HDMI devices having the physical addresses of [Physical Address of Terminating Devices 1] and [Physical Address of Terminating Devices 2] from the network.

Returning to FIG. 14, (i) in the case the television receiver 100 and source 1 are built in to some sort of network, the source 1 requests deactivation as to the activator, as described above. Thereafter, until transfer of the small-screen image data is completed, the television receiver 100 and source 1 does not perform a Response as to the CDC commands relating to HEC from the other HDMI devices. Thus, the existence of HEC is hidden from the other HDMI devices, access to the HEC by the other HDMI devices is inhibited, and the HEC can be used exclusively between the television receiver 100 and the source 1.

Now, let us consider the case wherein the CDC data having a <CDC_HEC_Discover> command message from another HDMI device is positioned in the data block is transmitted to the CEC line. This command message is for discovering a device capable of using HEC functions. The television receiver 100 and source 1 do not perform a response as to the command message herein. Thus, the HDMI device issuing the command message recognizes that the television receiver 100 and source do not have HEC functionality, or is not capable of currently using the functionality thereof, and thereby access does not occur.

(j) Upon completion of securing bandwidth for the transfer of HEC small-screen image data between the television receiver 100 and source 1, the source 1 starts the generation of small-screen image data and the transmission of the small-screen image data to the television receiver 100 through the bi-directional communication path (HEC). In this case, the source 1 performs scaling processing such as thinning processing as to the full-size image data, and generates small-screen image data in the image format corresponding to the above-described code appended to the <request HEC small-screen transfer start> command. Thus by transmission of small-screen image data starting from the source 1 to the television receiver 100, two-screen display wherein the small-screen image from the source 1 is displayed, is started at the television receiver 100.

Thus, by maintaining the frame rate of the small-screen image data as the same as the frame rate of the large-screen image data or lower, the timing is more readily matched at time of generating the two-screen on the television receiver 100 side, and the size of the frame buffer can be kept smaller. As described above, in the case of the image format of code 1 through code 3, the frame rate of the small-screen image data is the same as the frame rate of the large-screen image data or lower.

Note that the television receiver 100 can insert the small-screen image data transmitted from the source 1 at the size thereof in the large-screen image without performing resizing processing, or can insert in the large-screen image after having performed resizing processing and adjusting to an appropriate size. Also, the insertion position of the small-screen image as to the large-screen image can be adjusted to a convenient position based on user operations or the like.

(k) Subsequently, when a user performs picture-in-picture display stop operations (small-screen stop request), (l) the television receiver 100 transmits the <request HEC small-screen transfer stop> command to the source 1. (m) The source 1 stops generating and transmitting the small-screen image data. Thus, the two-screen display is stopped with the television receiver 100.

(n) The HEC between the television receiver 100 and source 1 is released from the exclusive state for transfer of the small-screen image data. Thereafter, the television receiver 100 and source 1 may issue appropriate CDC commands or respond to CDC commands from other devices so as to utilize the HEC in other applications.

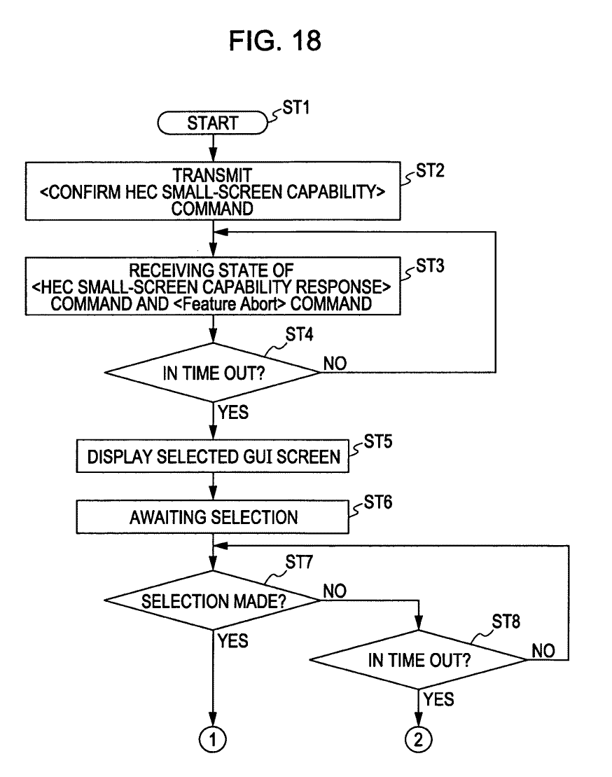

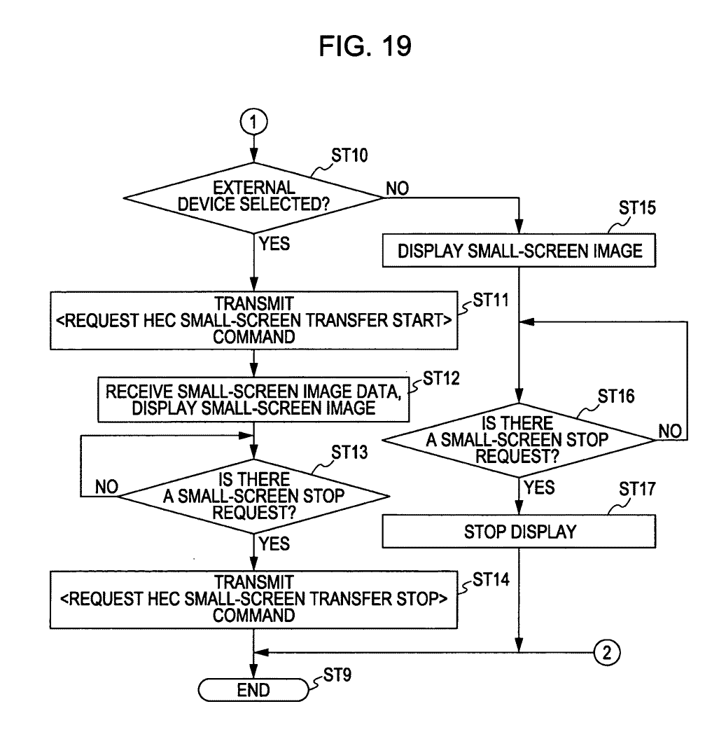

The flowcharts in FIGS. 18 and 19 show, of the sequence example shown in FIG. 14, the processing procedures of the television receiver 100. The television receiver 100 starts the processing of the small-screen display in step ST1, and thereafter moves to the processing in step ST2. In step ST2, the <confirm HEC small-screen capability> command is transmitted to the source devices (source 1 and source 2), according to small-screen display requests by the user. Subsequently, in step ST3, the television receiver 100 goes to a receiving state to receive the <HEC small-screen capability response> command or the <Feature Abort> command from the source device (source 1, source 2).

Next, the television receiver 100 determines in step ST4 whether or not a fixed amount of time has passed resulting in a time-out. When not in time-out, the flow returns to step ST3, and continues in the receiving awaiting state. When in time-out, in step ST5 the television receiver 100 displays a GUI screen for selecting the small-screen image and the size thereof on the large-screen image. In this case, the television receiver 100 displays the GUI screen, based on the <HEC small-screen capability response> command and <Feature Abort> command received in step ST3, and information accessory thereto. In step ST6, the television receiver 100 goes to a state of awaiting the small-screen image display selection by the user.

Next, the television receiver 100 determines whether or not display selection of the small-screen image has occurred in step ST7. When there is no display selection, in step ST8 the television receiver 100 determines whether or not a fixed amount of time has passed resulting in a time-out. When in time-out in step ST8, the television receiver 100 immediately advances to step ST9, and ends the processing of the small-screen display.

When there is a display selection in step ST7, in step ST10 the television receiver 100 determines whether or not the selection is for an external device. Now, the display selection of the small-screen image from the source devices (source 1, source 2) is selection of an external device, and display selection of the small-screen image from the internal tuner is not selection of an external device.

When the selection is of an external device, in step ST11 the television receiver 100 transmits the <request HEC small-screen transfer start> command to the selected external device (source 1 in the example in FIG. 14). In step ST12, the television receiver 100 receives small-screen image data from the external device herein through the bi-directional communication path (HEC), and performs two-screen display (picture-in-picture display) wherein the small-screen image is inserted in the large-screen image.

Next, in step ST13, the television receiver 100 determines whether or not there is a small-screen stop request from the user. When there is a small-screen stop request, in step ST14 the television receiver 100 transmits the <request HEC small-screen transfer stop> command to the source device transmitting the data of the displayed small-screen image. By the command transmission herein, transmission of the small-screen image data from the source device is stopped, and display of the small-screen image is stopped. Following the processing in step ST14, in step ST9 the television receiver 100 ends the processing of the small-screen display.

Also, when the selection in step ST10 described above is not for an external device, the television receiver 100 moves to the processing in step ST15. In step ST15, scaling processing and so forth is performed as to image data from the internal tuner and small-screen image data is generated, and two-screen display (picture-in-picture display) is performed wherein the small-screen image is inserted in the large-screen image.

Next, in step ST16 the television receiver 100 determines whether or not there is a small-screen stop request from the user. When there is a small-screen stop request, in step ST17 the television receiver 100 stops generation of the small-screen image data, and stops display of the small-screen image. Following the processing in step ST17, in step ST9 the television receiver 100 ends the processing of the small-screen display.

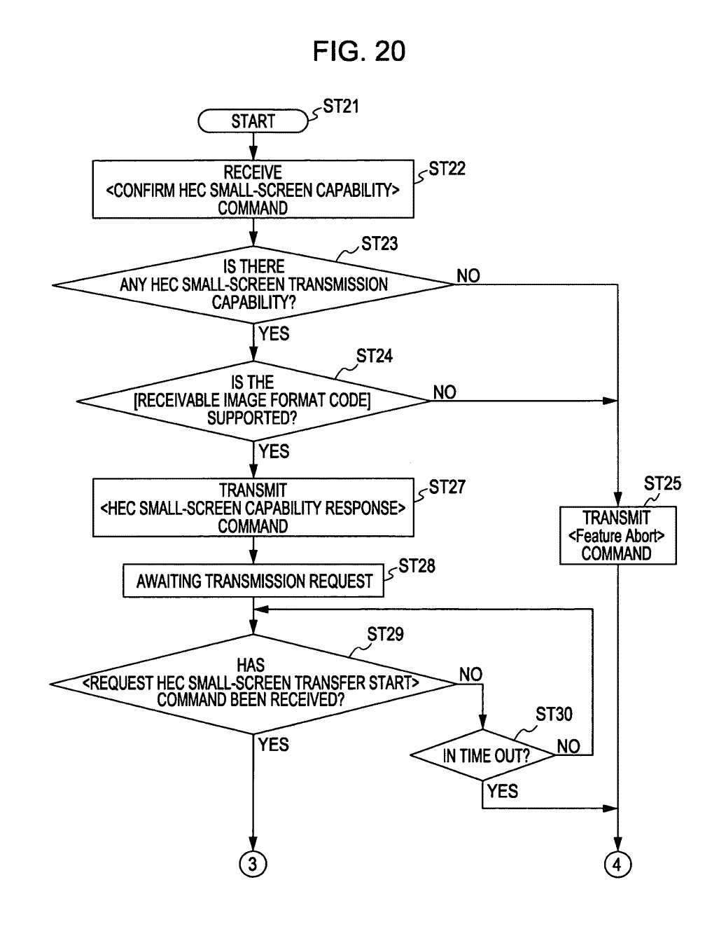

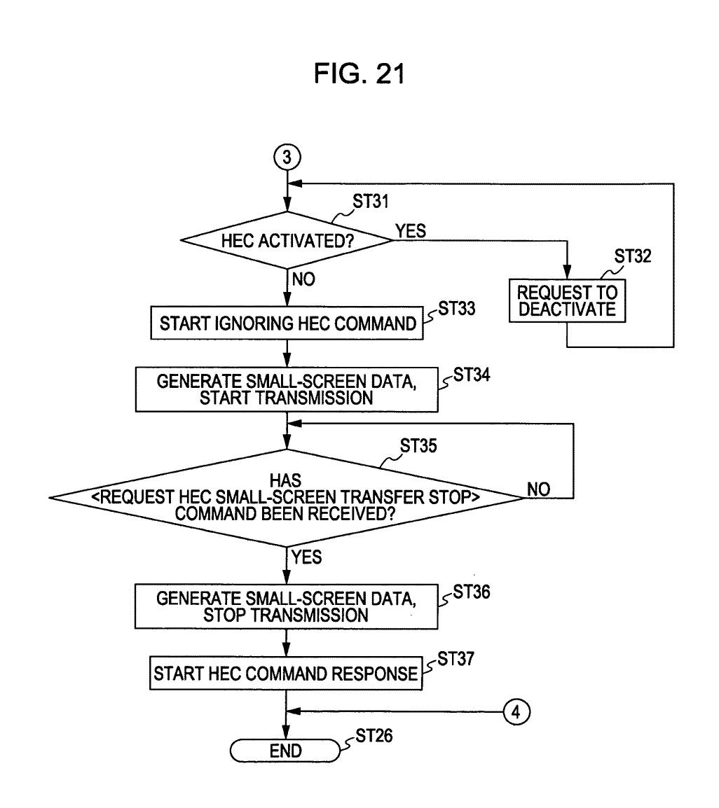

The flowcharts in FIGS. 20 and 21 show, of the sequence shown in FIG. 14, the processing procedures of the source devices (source 1 and source 2). In step ST21, the source devices start the processing, and thereafter move to the processing in step ST22. In step ST22, the source device receives the <confirm HEC small-screen capability> command from the television receiver 100.

Next, in step ST23 the source device determines whether or not the source device itself has the capability to transmit the small-screen image data with HEC. Also, when there is the capability thereof, in step ST24 the source device determines whether or not at least one of the receivable image format codes appended to the <confirm HEC small-screen capability> command is supported by the source device itself.

When there is no capability in step ST23, or when none of the receivable image format codes are supported in step ST 24, in step ST25 the source device transmits a <Feature Abort> command to the television receiver 100 in step ST25. Following the processing in step ST25, in step ST26 the source device ends the processing.

When one of the receivable image format codes is supported in step ST24, the source device moves to the processing in step ST27. In step ST27, the source device transmits the <HEC small-screen capability response> command to the television receiver 100. An image format code supported by the source device itself is appended to the command herein as a transmittable image format code.

Next, in step ST28 the source device goes to a state awaiting a transmission request for small-screen image data from the television receiver 100. In step ST29, the source device determines whether or not the <request HEC small-screen transfer stop> command has been received from the television receiver 100. When the command has not been received, the source device determines in step ST30 whether or not a fixed amount of time has passed, resulting in a time-out. When in time-out, in step ST26 the source device ends the processing.

Upon having received the <request HEC small-screen transfer stop> command in step ST29, the source device moves to step ST31. In step ST31, the source device determines whether or not the source device itself and the television receiver 100 are built in to some network, i.e. whether the HEC has been activated. When the HEC is activated, in step ST32 the source device performs a deactivate request as to the activator of the network. In this case, the source device uses an HDMI CDC command, for example.

When the HEC is not activated in step ST31, in step ST33 the source device starts an ignoring state wherein no response is performed as to the CDC commands relating to HEC from another HDMI device. Note that although not mentioned in the description of the flowcharts of FIGS. 18 and 19 described above, similar to the source device, the television receiver 100 also starts an ignoring state wherein no response is performed as to the CDC commands relating to HEC from another HDMI device.

Next, in step ST34, the source device generates small-screen image data, and starts transmitting the generated small-screen image data to the television receiver 100 through the bi-directional communication path (HEC). Ni this case, the source devices generates small-screen image data in the image format corresponding to the code appended to the <request HEC small-screen transfer start> command described above.

Next, in step ST35, the source device determines whether or not the <request HEC small-screen transfer stop> command has been received from the television receiver 100. Upon receiving the command thereof, in step ST36 the source device stops the generation and transmission of the small-screen image data. In step ST37, the source device issues a CDC command, or starts a response to the CDC command from another device, as appropriate, so as to utilize HEC to another application. Following the processing step ST37, in step ST26 the source device ends the processing.

As described above, with the AV system 10 shown in FIG. 1, when the user performs picture-in-picture display operations, the <confirm HEC small-screen capability> command is transmitted from the television receiver 100 to the external device (gaming device 200, disc player 300). When the small-screen image data in an image format receivable by the television receiver 100 is transmittable through the bi-directional communication path (HEC), the <HEC small-screen capability response> command is transmitted from the external device to the television receiver 100.

Upon the user selecting the small-screen image display from an external device (gaming device 200 or disc player 300), the <request HEC small-screen transfer start> command is transmitted from the television receiver 100 to the external device. In response to the command herein, small-screen image data is generated at the external device, and the generated small-screen image data thereof is transmitted to the television receiver 100 through the bi-directional communication path (HEC).

Therefore, when there is capability for the external device (gaming device 200, disc player 300) to transmit the small-screen image data of an image format receivable by the television receiver 100 through the bi-directional path (HEC), the small-screen image data can be used with the television receiver 100. That is to say, with the television receiver 100, two-screen display can be performed wherein the small-screen image from the external device is inserted in the large-screen image.

Now, the television receiver 100 can display an image with the full-size image data transmitted from the gaming device 200 by the TMDS channel as a large-screen image, and display a two-screen image wherein the small-screen image from the disc-player 300 is inserted in the large-screen image. Also, conversely, the television receiver 100 can display an image from the full-size image data transmitted from the disc player 300 by the TMDS channel as a large-screen image, and display the two-screen image wherein the small-screen image from the gaming device 200 is inserted in the large-screen image. Therefore, with the AV system 10 shown in FIG. 1, a two-screen display by the image from two digital connection source devices can be performed.

Also, with the AV system 10 shown in FIG. 1, the small-screen image data transmitted from the external device (gaming device 200, disc player 300) to the television receiver 100 through the bi-directional communication path (HEC) is non-compressed data. Therefore, the encoding by the external device and the decoding by the television receiver 100 do not have to be performed, processing load is lightened, and two-screen display can be readily performed.

Also, with the AV system 10 shown in FIG. 1, a deactivate request is performed as to the deactivator by the external device (gaming device 200, disc player 300) that received the <request HEC small-screen transfer start> command. The deactivate request herein is performed in the case that the external device itself and the television receiver 100 are built into some network, i.e. that the HEC has been activated. With the deactivate request, the external device itself and the television receiver 100 are separated from the network. Accordingly, transmission of the small-screen image data using the bi-directional communication path (HEC) from the external device to the television receiver 100 can be smoothly performed without obstruction to access by other devices.

### Second Embodiment

### Configuration of AV System

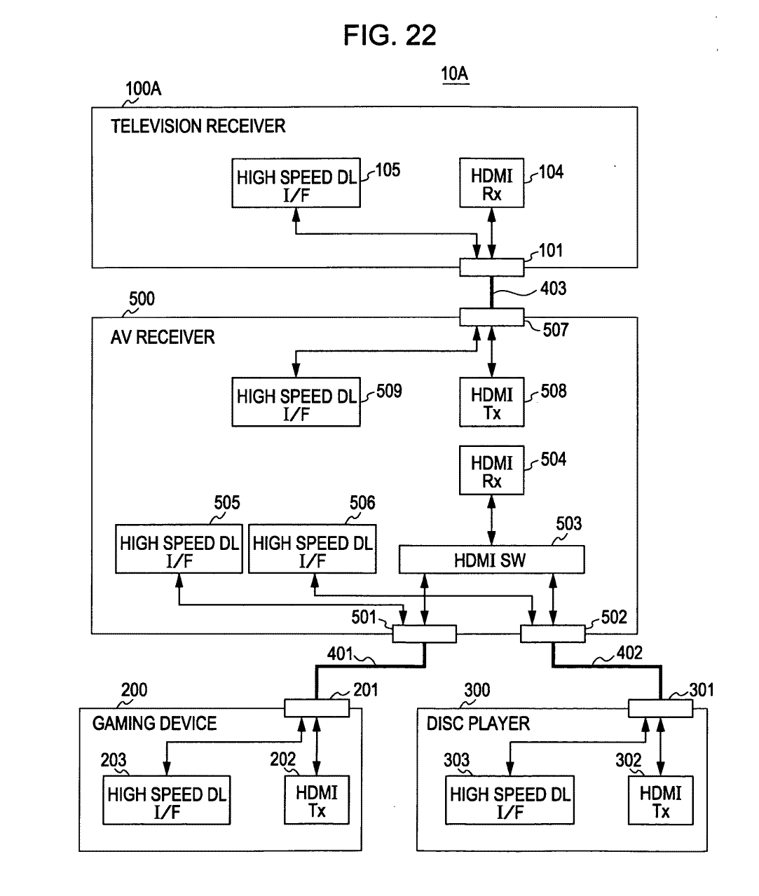

FIG. 22 shows a configuration example of an AV (Audio and Visual system 10A according to a second embodiment. The AV system 10A is made up with a television receiver 100A serving as a sink device, a gaming device 200 and disc player 300 serving as source devices, and an AV receiver 500 serving as a repeater device having been connected. With the AV system 10A, the various devices support a communication function using a bi-directional communication path with a utility line and HPD line making up an HDMI cable, i.e. an HEC (HDMI Ethernet Channel).

The AV receiver 500 and gaming device 200 are connected via an HDMI cable 401. Also, the AV receiver 500 and disc player 300 are connected via an HDMI cable 402. The AV receiver 500 has an HDMI terminal 501 provided thereto, which is connected to an HDMI receiving unit (HDMIRx) 504 via an HDMI switcher (HDMISW) 503, and is connected to a high speed data line interface (high speed DL I/F) 505. Also, the AV receiver 500 has an HDMI terminal 502 provided thereto, which is connected to an HDMI receiving unit 504 via the HDMI switcher 503, and is connected to a high speed data line interface (high speed DL I/F) 506.

The gaming device 200 has an HDMI terminal 201 provided thereto, which is connected to an HDMI transmitting unit (HDMITx) 202 and high speed data line interface (high speed DL I/F) 203. Also, the disc player 300 has an HDMI terminal 301 provided thereto, which is connected to an HDMI transmitting unit (HDMITx) 302 and high speed data line interface (high speed DL I/F) 303.

One end of the HDMI cable 401 is connected to the HDMI terminal 501 of the AV receiver 500, and the other end of the HDMI cable 401 is connected to the HDMI terminal 201 of the gaming device 200. Also, one end of the HDMI cable 402 is connected to the HDMI terminal 502 of the AV receiver 500, and the other end of the HDMI cable 402 is connected to the HDMI terminal 301 of the disc player 300.

Also, the television receiver 100A and AV receiver 500 are connected via an HDMI cable 403. The television receiver 100A is provided with an HDMI terminal 101 which is connected to an HDMI receiving unit (HDMIRx) 104 and a high speed data line interface (high speed DL I/F) 105. The AV receiver 500 is provided with an HDMI terminal 507 which is connected to an HDMI transmitting unit (HDMITx) 508 and a high speed data line interface (high speed DL I/F) 509. One end of the HDMI cable 403 is connected to the HDMI terminal 101 of the television receiver 100A, and the other end of the HDMI cable 403 is connected to the HDMI terminal 507 of the AV receiver 500.

While description of the detailed configuration will be omitted, the television receiver 100A has a configuration having removed the HDMI terminal 102, HDMI switcher 103, and high speed data line interface 106 from the television receiver 100 of the AV system 10 in FIG. 1 described above (see FIG. 6). Also, the gaming device 200 and disc player 300 have the same configuration as the gaming device 200 and disc player 300 of the AV system 10 in FIG. 1 described above (see FIGS. 7 and 8).

### Configuration Example of AV Receiver

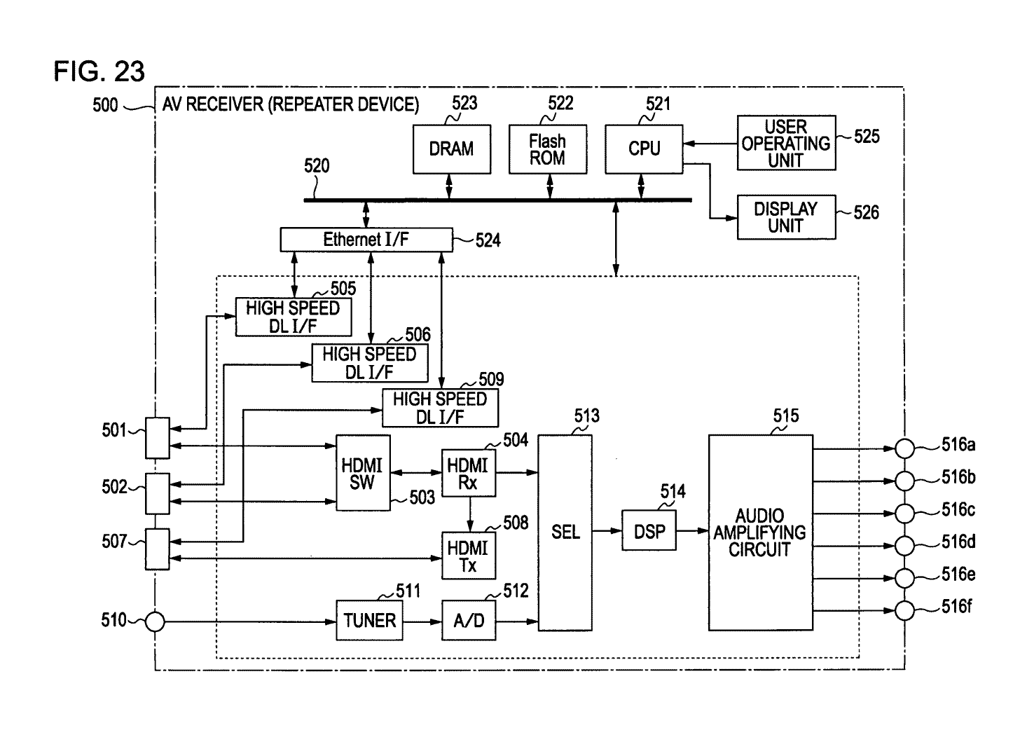

FIG. 23 shows a configuration example of the AV receiver 500. The AV receiver 500 has HDMI terminals 501 and 502, an HDMI switcher 503, HDMI receiving units (HDMIRx) 504, and high speed data line interfaces (high speed DL I/F) 505 and 506. Also, the AV receiver 500 has an HDMI terminal 507, HDMI transmitting unit (HDMITx) 508, and high speed data line interface (high speed DL I/F) 509.

Also, the AV receiver 500 has an antenna terminal 510, an FM tuner 511, an A/D converter 512, and a selector 513. Also, the AV receiver 500 has a DSP (Digital Signal Processor) 514, audio amplifying circuit 515, and audio output terminal 516a through 516f. Also, the AV receiver 500 has an internal bus 520, CPU 521, flash ROM 522, DRAM 523, Ethernet interface 524, user operating unit 525, and display unit 526. The CPU 521, flash ROM 522, DRAM 523, and Ethernet interface 524 are connected to the internal bus 520.

The CPU 521 controls the operations of various parts of the AV receiver 500. Also, the CPU 521 performs communication of control information as appropriate with other devices, through the HDMI/CEC network which is made up of a CEC line which is a control data line of the HDMI cables 401 through 403. The flash ROM 522 stores the control software and holds data. The DRAM 523 makes up the work area of the CPU 521. The CPU 521 opens the software and data read out from the flash ROM 522 on the DRAM 523 and starts up the software, controls the various parts of the AV receiver 500, and also performs communication of control information with other devices.

The user operating unit 525 and display unit 526 are connected to the CPU 521. The user operating unit 525 and display unit 526 make up the user interface. With the user operating unit 525, the user can perform selection of output audio of the AV receiver 500, selection of the FM tuner 511, operating settings, and so forth. The user operating unit 525 is made up of keys, buttons dials, remote control transmission/reception devices and so forth in an unshown casing of the AV receiver 500. The display unit 526 displays the operating state of the AV receiver 500, user operation state and so forth, and is made up of an LCD (Liquid Crystal Display) or the like.

The antenna terminal 510 is a terminal to input an FM broadcast signal received with an unshown FM receiving antenna. The FM tuner 511 processes the FM broadcast signals input in the antenna terminal 510, and outputs analog audio signals on the left and right corresponding to the channels selected by the user. The A/D converting device 512 converts the analog audio signals output from the FM tuner 511 into digital audio data and supplies this to the selector 513.

The HDMI switcher 503 selectively connects the HDMI terminals 501 and 502 to the HDMI receiving unit 504. The HDMI receiving unit 504 is selectively connected to one of the HDMI terminals 501 and 502 via the HDMI switcher 503. The HDMI receiving unit 504 receives non-compressed (base band) image and audio data transmitted in one direction from the external device (source device) connected to the HDMI terminals 501 and 502, by communication conforming to HDMI.

The HDMI receiving unit 504 supplies the audio data to the selector 513, and supplies the image and audio data to the HDMI transmitting unit 508. The HDMI transmitting unit 508 transmits the non-compressed image and audio data, supplied from the HDMI receiving unit 504, from the HDMI terminal 507 with communication following HDMI standards. Thus, the AV receiver 500 exerts the function of a repeater. While detailed description will be omitted, the HDMI receiving unit 504 and HDMI transmitting unit 508 are configured similar to the HDMI receiving units and HDMI transmitting unit which the various devices of the AV system 10 in FIG. 1 described above have (see FIG. 9).

The high speed data line interfaces 505, 506, and 509 are bi-directional communication path (HEC) interfaces made up of a utility line and HPD line of the HDMI cable connected to the HDMI terminals 501, 502, and 507. The high speed data line interfaces 505, 506, and 509 are inserted between the Ethernet interface 524 and the HDMI terminals 501, 502, and 507. While detailed description will be omitted, the high speed data line interfaces 505, 506, and 509 are configured similar to the high speed data line interfaces which the various devices of the AV system 10 in FIG. 1 described above have (see FIG. 13).

The selector 513 selectively takes out the audio data supplied from the HDMI receiving unit 504 or the audio data supplied from the A/D converter 512, and supplies this to A DSP 514. The DSP 514 processes the audio data obtained with the selector 513, and for example performs processing to generate audio data of various channels to realize 5.1 ch surround sound, processing to append predetermined acoustic field features, processing to convert digital signals into analog signals, and so forth.

The audio amplifying circuit 515 amplifies a front left audio signal SFL, front right audio signal SFR, front center audio signal SFC, rear left audio signal SRL, rear right audio signal SRR, and sub-woofer audio signal Ssw, which are output from the DSP 514. The audio amplifying circuit 515 outputs the various amplified audio signals to the audio output terminals 516a through 516f.

Note that while omitted from the drawings, a front left speaker, front right speaker, front center speaker, rear left speaker, rear right speaker, and sub-woofer speaker making up a speaker group are connected to the audio output terminals 516a through 516f.

Operations of the AV receiver 500 shown in FIG. 23 will be described briefly. With the HDMI receiving unit 504, the non-compressed image and audio data input to the HDMI terminals 501 and 502 are obtained via the HDMI cable. The image and audio data is supplied to the HDMI transmitting unit 508, and transmitted to the HDMI cable that is connected to the HDMI terminal 507.

Also, the audio data obtained with the HDMI receiving unit 504 is supplied to the selector 503. With the selector 513, the audio data supplied from the HDMI receiving unit 504 or the audio data supplied from the A/D converter 512 is selectively taken out, and supplied to the DSP 514. The DSP 514 performs processing to generate audio data of various channels to realize 5.1 ch surround sound, processing to append predetermined acoustic field features, processing to convert digital signals into analog signals, and so forth. The audio signals for the various channels output from the DSP 514 will be output from the audio output terminals 516a through 516f via the audio amplifying circuit 515.

In the case of viewing/listening to images and audio from the image data and audio data from the disc player 300 with the AV system 10A shown in FIG. 22, and when the AV receiver 500 is in a state wherein the system audio mode is ON, the operations thereof is as follows. That is to say, the HDMI terminal 502 is connected to the HDMI receiving unit 504 with the HDMI switcher 503. Also, the audio data from the HDMI receiving unit 504 is taken out with the selector 513. Thus, audio signals for the various channels relating to the audio data from the disc player 300 is output to the audio output terminals 516a through 516f. Therefore, audio from the audio data from the disc player 300 is output from the speaker group connected to the AV receiver 500.

Note that in the case of viewing/listening to images and audio of the image data and audio data from the disc player 300, and when the AV receiver 500 is in a state wherein the system audio mode is OFF, the audio amplifying circuit 515 is in a muted state. Thus, audio signals are not supplied to the audio output terminals 516a through 516f.

While detailed description will be omitted, in the case of viewing/listening to images and audio of the image data and audio data from the gaming 200 with the AV system 10A in FIG. 22, operations are similar to the case of viewing/listening to images and audio of the image data and audio data from the disc player 300.

With the AV system 10A shown in FIG. 22, images and audio from an unshown internal tuner can be viewed/listened to with the television receiver 100A.

Also, images and audio from the gaming device 200 can be viewed/listened to with the television receiver 100A. In this case, the non-compressed images and audio data are transmitted with a TMDS channel of the HDMI cable 401 to the AV receiver 500. With the AV receiver 500, the HDMI terminal 501 is connected to the HDMI receiving unit 504 by the HDMI switcher 503. Therefore, the non-compressed images and audio data from the gaming device 200 are obtained with the HDMI receiving unit 504.

The non-compressed image and audio data is transmitted from the HDMI transmitting unit of the AV receiver 500 to the television receiver 100A with a TMDS channel of the HDMI cable 403. Thus, non-compressed image and audio data is obtained from the gaming device 200 with the HDMI receiving unit 104 of the television receiver 100A, and image display and audio output from the gaming device 200 are performed.

Also, images and audio from the disc player 300 can be viewed/listened to with the television receiver 100A. In this case, the non-compressed images and audio data are transmitted to the AV receiver 500 with a TMDS channel of the HDMI cable 402. With the AV receiver 500, the HDMI terminal 502 is connected to the HDMI receiving unit 504 by the HDMI switcher 503. Therefore, the non-compressed images and audio data from the disc player 300 are obtained with the HDMI receiving unit 504.

The non-compressed image and audio data is transmitted from the HDMI transmitting unit of the AV receiver 500 to the television receiver 100A with a TMDS channel of the HDMI cable 403. Thus, non-compressed image and audio data is obtained from the disc player 300 with the HDMI receiving unit 104 of the television receiver 100A, and image display and audio output from the disc player 300 are performed.

With the AV system 10A shown in FIG. 22, in the state of displaying the image of an unshown internal tuner with the television receiver 100A, images from the gaming device 200 or disc player 300 can be displayed as small-screen images. In this case, small-screen image data of a predetermined size is generated with the gaming device 200 or disc player 300. That is to say, normally, scaling processing such as thinning processing is performed as to the full-size image data transmitted with the TMDS (Transition Minimized Differential Signaling) channel, and small-screen image data is obtained. The small-screen image data thereof is transmitted from the gaming device 200 or disc player 300 to the television receiver 100 via the AV receiver 500, using the bi-directional communication path (HEC).

In order to display the small-screen images as described above, the user performs picture-in-picture display operations (small-screen display request) in the state that images from the internal tuner is being displayed. Corresponding to the operations thereof, the television receiver 100A transmits the above-described <confirm HEC small-screen capability> to the gaming device 200 and disc player 300, through the HDMI/CEC network.

In response to the command herein, the gaming device 200 and disc player 300 sends back the <HEC small-screen capability response> or <Feature Abort> command to the television receiver 100A, through the HDMI/CEC network. The television receiver 100A displays a GUI screen for selecting the small-screen image and the size thereof on the large-screen image, based on the commands sent back from the gaming device 200 and disc player 300 (see FIG. 2).

When the user desires a display of small-screen images from the gaming device 200 or disc player 300, the user selects a desired size of gaming device 200 or disc player 300, based on the GUI screen. According to the operation herein, the television receiver 100A transmits the above-described <request HEC small-screen transfer start> command to the gaming device 200 or disc player 300 through the HDMI/CEC network.

Now, in the case that the gaming device 200 or disc player 300 have itself, the AV receiver 500, and the television receiver 100A built into some network, i.e. in the case that the HEC is activated, the gaming device 200 or disc player 300 requests deactivation to the deactivator. The gaming device 200 and disc player 300 determine whether or not itself, the AV receiver 500, and the television receiver 100A are built into some network, each time the above-described <request HEC small-screen transfer start> command is transmitted. By the gaming device 200 and disc player 300 performing a deactivating request to the deactivator, the various devices herein become independent from the HDMI HEC network, and all of the HEC data transfer bands can be secured for transfer of small-screen image data.

In response to the <request HEC small-screen transfer start> command, the gaming device 200 or disc player 300 starts generating the small screen image data and transmitting the small-screen image data herein to the television receiver 100A through the bi-directional path (HEC). The television receiver 100A performs two-screen display wherein the small-screen image from the gaming device 200 is inserted in the image from the internal tuner, based on the small-screen image data transmitted from the gaming device 200 or disc player 300 (see FIG. 3).

In order to stop the display of the small-screen image in the state of the small-screen being displayed as described above, the user performs picture-in-picture display stopping operations (small-screen stop request). Corresponding to the operation herein, the television receiver 100A transmits the above-described <request HEC small-screen stop> command to the gaming device 200 or disc player 300, through the HDMI/CEC network. In response to the command herein, the gaming device 200 or disc player 300 stop the generating and transmitting of the small-screen image data. Thus, two-screen display is stopped with the television receiver 100A.

Also, in order to display enlarged images (full images) of the gaming device 200 or disc player 300, the user performs enlarging operations of the small-screen image. Corresponding to the operations herein, the television receiver 100A transmits the above-described <request HEC small-screen transfer stop/enlarge> command through the HDMI/CEC network.

In response to the command herein, the gaming device 200 or disc player 300 stops the generating and transmitting of the small-screen image data. The gaming device 200 or disc player 300 then transmits the full-size image data and audio data from the HDMI transmitting unit to the television receiver 100A via the AV receiver 500 with the TMDS channel. The television receiver 100A obtains non-compressed image and audio data from the gaming device 200 or disc player 300 with the HDMI receiving unit 104. The television receiver 100A then displays the full-size images from the gaming device 200 or disc player 300, while outputting the audio thereof.

Also, with the AV system 10A shown in FIG. 22, images from the internal tuner or disc player 300 can be displayed as small-screen image, while in the state of displaying images from the gaming device 200 with the television receiver 100A. In this case, full-size image data is transmitted from the gaming device 200 to the television receiver 100A via the AV receiver 500 through the TMDS channel. Also, in this case, small-screen image data of a predetermined size is generated at the television receiver 100A or disc player 300. In the case of displaying the images from the disc player 300 as small-screen images, the small-screen image data is transmitted from the disc player 300 to the AV receiver 500, using the bi-directional communication path (HEC).

In order to display the small-screen images as described above, the user performs picture-in-picture display operations (small-screen display request) while the images from the gaming device 200 are in a state of being displayed. Corresponding to the operations herein, the television receiver 100A transmits the above-described <confirm HEC small-screen capability> command through the HDMI/CEC network.

In response to the command herein, the gaming device 200 and disc player 300 send back the <HEC small-screen capability response> command or <Feature Abort> command through the HDMI/CEC network. The television receiver 100A displays a GUI screen for selecting the small-screen image and the size thereof on the large-screen image, based on the command thus sent back from the gaming device 200 and disc player 300.

When the user desires to display the small-screen images from the internal tuner, the user selects a desired size of internal tuner, based on the GUI screen. According to the operation herein, the television receiver 100A generates small-screen image data corresponding to the selected size. Based on the small-screen image data, the television receiver 100A performs two-screen display, wherein the small-screen image from the internal tuner is inserted into the image from the gaming device 200.

In order to stop the display of the small-screen images while in the state of the small-screen being displayed as described above, the user performs picture-in-picture display stopping operations (small-screen stop request). Corresponding to the operations herein, the television receiver 100A stops the generating of the small-screen image data, and stops the two-screen display.

Also, in order to display enlarged images (full images) from the internal tuner while in the state of the small-screen being displayed as described above, the user performs enlarging operations of the small-screen image. Corresponding to the operations herein, the television receiver 100A stops the generating of the small-screen image data. The television receiver 100A then uses the image and audio data obtained from the internal tuner instead of the image and audio data obtained with the HDMI receiver unit 104. Thus, the television receiver 100A displays the full-size images from the internal tuner, while outputting the audio thereof.

Also, when the user desires display of the small-screen images from the disc player 300, the user selects the desired size of the disc player 300, based on the GUI screen. According to the operation herein, the television receiver 100A transmits the above-described <request HEC small-screen transfer start> command to the disc player 300 through the HDMI/CEC network.

In response to the command herein, the disc player 300 starts generating the small-screen image data and transmitting the small-screen image data herein to the television receiver 100A through the bi-directional communication path (HEC). Thus, two-screen display is performed, wherein the small-screen images from the disc player 300 is inserted into the images from the gaming device 200, based on the small-screen image data transmitted from the disc player 300 (see FIG. 5).

In order to stop the display of the small-screen image in the state of the small-screen being displayed as described above, the user performs picture-in-picture display stopping operations (small-screen stop request). Corresponding to the operation herein, the television receiver 100A transmits the above-described <request HEC small-screen transfer stop> command to the disc player 300, through the HDMI/CEC network. In response to the command herein, the disc player 300 stops the generating and transmitting of the small-screen image data. Thus, two-screen display is stopped with the television receiver 100A.

Also, in order to display enlarged images (full images) from the disc player 300, while in the state of the small-screen being displayed as described above, the user performs enlarging operations of the small-screen image. Corresponding to the operations herein, the television receiver 100A transmits the above-described <request HEC small-screen transfer stop/enlarge> command through the HDMI/CEC network to the disc player 300.

In response to the command herein, the disc player 300 stops the generating and transmitting of the small-screen image data, and transmits the full-size image data and audio data from the HDMI transmitting unit 302 to the television receiver 100A via the AV receiver 500 with the TMDS channel. At this time, the HDMI switcher 503 of the AV receiver 500 switches from a state wherein the HDMI terminal 501 is connected to the HDMI receiving unit 504, to a state wherein the HDMI terminal 502 is connected to the HDMI receiving unit 504.

The HDMI receiving unit 104 of the television receiver 100A obtains the non-compressed images and audio from the disc player 300 instead of the non-compressed image and audio data obtained from the gaming device 200. Thus, the television receiver 100A displays the full-size images from the disc player 300, while outputting the audio thereof.

Also, with the AV system 10A shown in FIG. 22, while in the state of displaying images from the disc player 300 with the television receiver 100A, images from the internal tuner or gaming device 200 can be displayed as small-screen images. In this case, full-size image data is transmitted from the disc player 300 to the television receiver 100A via the AV receiver 500, with the TMDS channel. Also, in this case, small-screen image data of a predetermined size is generated with the television receiver 100A or gaming device 200. In the case of displaying the images from the gaming device 200 as the small-screen images, the small-screen image data herein is transmitted from the gaming device 200 to the television receiver 100A via the AV receiver 500, using the bi-directional communication path (HEC).

In order to display the small-screen images as described above, the user performs picture-in-picture display operations (small-screen display request) while images from the disc player 300 are in the state of being displayed. Corresponding to the operation herein, the television receiver 100A transmits the above-described <confirm HEC small screen capability> command to the gaming device 200 and disc player 300 through the HDMI/CEC network.

In response to the command herein, the gaming device 200 and disc player 300 send back the <HEC small-screen capability response> command or the <Feature Abort> command to the television receiver 100A through the HDMI/CEC network. The television receiver 100A displays a GUI screen for selecting the small-screen images and the size thereof on the large-screen image, based on the commands sent back from the gaming device 200 and disc player 300.

When the user desires to display the small-screen images from the internal tuner, the user selects the predetermined size of the internal tuner, based on the GUI screen. According to the operation herein, the television receiver 100A generates small-screen image data corresponding to the selected size. The television receiver 100A performs two-screen display wherein the small-screen images from the internal tuner are inserted into the image from the disc player 300, based on the small-screen image data herein.

In order to stop the display of the small-screen image in the state of the small-screen being displayed as described above, the user performs picture-in-picture display stopping operations (small-screen stop request). Corresponding to the operation herein, the television receiver 100A stops the generating of the small-screen image data, and stops the two-screen display.

Also, in order to display enlarged images (full images) from the internal tuner while in the state of the small-screen being displayed as described above, the user performs enlarging operations of the small-screen image. Corresponding to the operations herein, the television receiver 100A stops the generating of the small-screen image data. The television receiver 100A then uses the image and audio data obtained from the internal tuner instead of the image and audio data obtained with the HDMI receiver unit 104. Thus, the television receiver 100A displays the full-size images from the internal tuner, while outputting the audio thereof.

Also, when the user desires display of the small-screen images from the gaming device 200, the user selects the desired size of the gaming device 200, based on the GUI screen. According to the operation herein, the television receiver 100A transmits the above-described <request HEC small-screen transfer start> command to the gaming device 200 through the HDMI/CEC network.

In response to the command herein, the gaming device 200 starts generating the small-screen image data and transmitting the small-screen image data herein to the television receiver 100A through the bi-directional communication path (HEC). Thus, two-screen display is performed, wherein the small-screen images from the gaming device 200 is inserted into the images from the disc player 300, based on the small-screen image data transmitted from the gaming device 200.

In order to stop the display of the small-screen image in the state of the small-screen being displayed as described above, the user performs picture-in-picture display stopping operations (small-screen stop request). Corresponding to the operation herein, the television receiver 100A transmits the above-described <request HEC small-screen transfer stop> command to the gaming device 200, through the HDMI/CEC network. In response to the command herein, the gaming device 200 stops the generating and transmitting of the small-screen image data. Thus, two-screen display is stopped with the television receiver 100A.

Also, in order to display enlarged images (full images) from the gaming device 200, while in the state of the small-screen being displayed as described above, the user performs enlarging operations of the small-screen image. Corresponding to the operations herein, the television receiver 100A transmits the above-described <request HEC small-screen transfer stop/enlarge> command through the HDMI/CEC network to the gaming device 200.

In response to the command herein, the gaming device 200 stops the generating and transmitting of the small-screen image data, and transmits the full-size image data and audio data from the HDMI transmitting unit 302 to the television receiver 100A via the AV receiver 500 with the TMDS channel. At this time, the HDMI switcher 503 of the AV receiver 500 switches from a state wherein the HDMI terminal 502 is connected to the HDMI receiving unit 504, to a state wherein the HDMI terminal 501 is connected to the HDMI receiving unit 504.

The HDMI receiving unit 104 of the television receiver 100A obtains the non-compressed images and audio from the gaming device 200 instead of the non-compressed image and audio data obtained from the disc player 300. Thus, the television receiver 100A displays the full-size images from the gaming device 200, while outputting the audio thereof.

As described above, with the AV system 10A shown in FIG. 22, when the user performs picture-in-picture display operations, the <confirm HEC small-screen capability> command is transmitted from the television receiver 100A to an external device (gaming device 200, disc player 300). When the small-screen image data in the image format receivable by the television receiver 100A is transmittable through the bi-directional communication path (HEC), the <HEC small-screen capability response> command is transmitted from the external device to the television receiver 100A.

When the user selects display of small-screen images from the external device (gaming device 200 or disc player 300), the <request HEC small-screen transfer start> command is transmitted from the television receiver 100A to the external device thereof. In response to the command herein, small-screen image data is generated with the external device, and the generated small-screen image data thereof is transmitted to the television receiver 100A through the bi-directional communication path (HEC).

Therefore, when the external device (gaming device 200 or disc player 300) has the capability to transmit small-screen image data in an image format receivable by the television receiver 100A through the bi-directional communication path (HEC), the television receiver 100A can use the small-screen image data. That is to say, with the television receiver 100A, two-screen display can be performed, wherein the small-screen images from the external device can be inserted into the large-screen image.

Now, the television receiver 100A can display images from the full-size image data transmitted from the gaming device 200 as large-screen images through the TMDS channel, and can display a two-screen image wherein the small-screen images from the disc player 300 is inserted into the large-screen image thereof. Also, conversely, the television receiver 100A can display images from the full-size image data transmitted from the disc player 300 as large-screen images through the TMDS channel, and can display a two-screen image wherein the small-screen images from the gaming device 200 is inserted into the large-screen image thereof. Therefore, with the AV system 10A shown in FIG. 22, two-screen display with the images from two digital connection source devices that are connected to the AV receiver 500 can be performed.

Also, with the AV system 10A shown in FIG. 22, the small-screen image data transmitted from the external device (gaming device 200 or disc player 300) to the television receiver 100A through the bi-directional communication path (HEC) is non-compressed data. Therefore, the data does not have to be encoded with the external device or decoded with the television receiver 100A, whereby processing load is lightened and two-screen display can be readily performed.

With the AV system 10A shown in FIG. 22, a deactivate request is performed as to the deactivator with the external device (gaming device 200 or disc player 300) receiving the <request HEC small-screen transfer start> command. The deactivate request is performed in the case that the device itself, the AV receiver 500, and the television receiver 100A are built into some network, i.e. in the case that HEC is activated. With the deactivate request, the device itself the AV receiver 500, and the television receiver 100A are separated from the network. Accordingly, the transmission of small-screen image data using the bi-directional path (HEC) from the external device to the television receiver 100A can be smoothly performed without other devices obstructing access thereof.

### Modification

With the SV systems 10 and 10A shown in FIGS. 1 and 22, of the gaming device 200 and disc player 300, one is a Main Source, and the other a Sub Source. The main source is in the state wherein the non-compressed image and audio data can be transmitted to the television receivers 100 and 100A with the TMDS channel, but the sub source is not in a state wherein the non-compressed image and audio data can be transmitted to the television receivers 100 and 100A with the TMDS channel.

For example, with the AV system 10 shown in FIG. 1, when the HDMI terminal 101 is connected to the HDMI receiving unit 104 with the HDMI switcher 103, the gaming device 200 becomes the main source and the disc player 300 becomes the sub source. Also, for example, with the AV system 10 shown in FIG. 1, when the HDMI terminal 102 is connected to the HDMI receiving unit 104 with the HDMI switcher 103, the disc player 300 becomes the main source, and the gaming device 200 becomes the sub source.

Similarly, with the AV system 10 shown in FIG. 1, when the HDMI terminal 501 is connected to the HDMI receiving unit 504 with the HDMI switcher 503, the gaming device 200 becomes the main source and the disc player 300 becomes the sub source. Also, for example, with the AV system 10A shown in FIG. 22, when the HDMI terminal 502 is connected to the HDMI receiving unit 504 with the HDMI switcher 503, the disc player 300 becomes the main source, and the gaming device 200 becomes the sub source.

Controls such as playing and stopping the main source from the television receivers 100 and 100A are realized by using a currently existing DMICEC command group. However, the sub source is assumed to not be an active source of the HDMI network wherein the television receivers 100 and 100A are a Root thereof, whereby general HDMICEC commands may not be able to be used.

Thus, control of the sub source may be realized by using a bandwidth (roughly 1 Kbps is sufficient) remaining from the bi-directional communication path (HEC) to exchange control signals between the television receivers 100 and 100A and the sub source. Also, control may be realized by defining Deck Control commands such as Play and Stop, Tuner Control commands such as <Tuner Step Increment> and so forth with HEC, other than the active source.

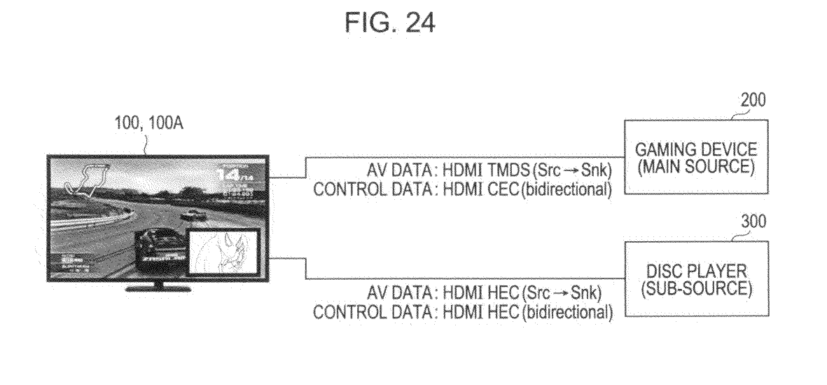

FIG. 24 shows a schematic flow of AV data and control data between the television receivers 100 and 100A, the gaming device 200, and the disc player 300. The example in FIG. 24 shows a case wherein the gaming device 200 is the main source, and the disc player 300 is the sub source.

As shown in the diagram, the AV data is transmitted in a one-directional stream from the source (gaming device 200, disc player 300) to the television receivers 100 and 100A (expressed as “Src→Snk” in the diagram). Conversely, the control data is exchanged bi-directionally (expressed as “bidirectional” in the diagram) with the television receivers 100 and 100A, as unsynchronized with the AV data.

When the user instructs the exchange of main source and sub source by instructions from a remote control of the television receivers 100 and 100A, the sub source up to that time is switched with the main source. In this case, the source device which had been the sub source up to that time becomes the main source, whereby transfer of the full-size video data can be started via the HDMI TMDS channel, and the control signals can also be exchanged via the HDMICEC.

Note that according to the above-described embodiments, codes indicating all of the image formats that the gaming device 200 or disc player 300 can transmit are appended to the <HEC small-screen capability response> command which the gaming device 200 and disk player 300 transmit to the television receiver 100 and 100A. A GUI screen is displayed with the television receiver 100 and 100A, based on the transmittable image format information, and the size, i.e. image format, is selected by the user.

However, the gaming device 200 and disc player 300 may append, to the <HEC small-screen capability response> command, only the one image format code selected from the image formats transmittable by itself. In this case, for example, of the image formats transmittable by itself, the image format having the highest data rate is selected as the transmission planned image format.

In this case, unlike the above-described embodiments, the user is not capable of performing selection of size, i.e. selection of the image format, with the television receiver 100 and 100A. In this case, a fixed size of small-screen image data is received from the gaming device 200 and disc player 300 with the television receivers 100 and 100A, but with the scaling processing and so forth for itself, the size of the small-screen image to be inserted into the large-screen image can be optionally adjusted.

Also, according to the above-described embodiments, the small-screen image data transmitted from the gaming device 200 and disc player 300 to the television receivers 100 and 100A, using the bi-directional communication path (HEC), is non-compressed data (code 1 through code 3). However, the small-screen image data can also be compression-encoded and transmitted. In this case, even if the size is increased or the frame rate increased as to the image formats of code 1 through code 3 described above, the data rate of the transmission data can be kept to a value smaller than the maximum transfer rate, e.g. 100 Mbps, of the bi-directional communication path (HEC).

Also, according to the above-described embodiments, the bi-directional communication path (HEC) is used to transfer the small-screen image data from the gaming device 200 and disc player 300 to the television receivers 100 and 100A. It goes without saying that transferring the control data such as the audio data and metadata using the bi-directional communication path (HEC) can be realized with a similar method.

Also, according to the above-described embodiments, the television receivers 100 and 100A are shown serving as HDMI sink devices, the gaming device 200 and disc player 300 as HDMI source devices, and the AV receiver 500 as an HDMI repeater device, but the various devices are not limited to these.

Also, according to the above-described embodiments, examples have been described wherein various devices are connected with an HDMI cable. However, the present invention can be similarly applied to an AV system realized by wireless transmission paths for the various devices.

It should be understood by those skilled in the art that various modifications, combinations, sub-combinations and alterations may occur depending on design requirements and other factors insofar as they are within the scope of the appended claims or the equivalents thereof.

What is claimed is:

1. A receiving device comprising:
a first data receiving unit to receive image data from an external device, with multiple channels, by differential signals, via a transfer path;
a second data receiving unit to receive predetermined data from said external device, via a bi-directional communication path made up using predetermined lines of said transfer path;
a capability confirming unit to confirm the existence of capability to transmit said predetermined data to said external device, via said bi-directional communication path; and
a transmission request unit to request transmission of said predetermined data to said external device when confirmation is made by said capability confirming unit that said external device has said capability.

2. The receiving device according to claim 1, wherein said predetermined data received by said second data receiving unit is small screen image data to display small-screen images of a predetermined size.

3. The receiving device according to claim 2, wherein said small-screen image data is non-compressed image data.

4. The receiving device according to claim 2 or 3, further comprising:
an image display unit to perform two-screen display, based on said image data received with said first data receiving unit and said small-screen image data received with said second data receiving unit.

5. The receiving device according to claim 2 or 3, further comprising:
connecting units of a plurality of transfer paths; and
an image display unit to perform two-screen display, based on said image data received with said first data receiving unit relating to a first transfer path of said plurality of transfer paths, and said small screen image data received with said second data receiving unit relating to a second transfer path which differs from said first transfer path of said plurality of transfer paths.

6. The receiving device according to claim 1, wherein said capability confirming unit confirms the existence of said capability on said external device, via a control data line of said transfer path; and wherein
said transmission request unit requests transmission of said predetermined data on said external device via the control data line.

7. The receiving device according to claim 6, wherein said control data line makes up an HDMI/CEC network.

8. The receiving device according to claim 1, further comprising:
a control information transmitting unit to transmit control information that controls operations of said external device which transmits said predetermined data received with said second data receiving unit, to the external device.

9. A receiving method comprising the steps of:
first receiving, of image data from an external device, with multiple channels, by differential signals, via a transfer path;
second receiving, of predetermined data from said external device, via a bi-directional communication path made up using predetermined lines of said transfer path; and
confirming, of the existence of capability to transmit said predetermined data to said external device, via said bi-directional communication path; and
requesting transmission of said predetermined data to said external device when confirmation is made in said confirming that said external device has said capability.

10. A transmitting device comprising:
a first data transmitting unit to transmit image data to an external device, with multiple channels, by differential signals, via a transfer path;
a second data transmitting unit to transmit predetermined data to said external device, via a bi-directional communication path made up using predetermined lines of said transfer path;
a capability confirming response unit to respond as to the confirmation of the existence of capability to transmit said predetermined data to said external device, via said bi-directional communication path; and
a transmission request unit to receive transmission requests of said predetermined data from said external devices, wherein
said second data transmitting device transmits said predetermined data to said external device via said bi-directional communication path, when said transmission request is received with said transmission request receiving unit.

11. The transmitting device according to claim 10, wherein said predetermined data transmitted by said second data transmitting unit is small screen image data to display small-screen images of a predetermined size.

12. The transmitting device according to claim 11, wherein said small-screen image data is non-compressed image data.

13. The transmitting device according to claim 11 or 12, further comprising:
an image display generating unit to generate said small-screen image data transmitted with said second data transmitting unit, based on said image data transmitted with said first data transmitting unit.

14. The transmitting device according to claim 10, wherein said capability confirming response unit responds as to said external device, via a control data line of said transfer path; and wherein
said transmission request receiving unit receives transmission requests for said predetermined data from said external device via the control data line.

15. The transmitting device according to claim 14, wherein said control data line makes up an HDMI/CEC network.

16. The transmitting device according to claim 10, further comprising:
a control information receiving unit to receive control information that is transmitted via said bi-directional communication path from said external device.

17. The transmitting device according to claim 10, further comprising:
a deactivate request unit to request deactivation as to an activator of the network upon receiving said transmission request by said transmission request receiving unit, in the case that said external device and said transmitting device itself are built into a network using said bi-directional communication path.

18. The transmitting device according to claim 17, wherein said deactivate request unit requests deactivation as to said activator via a control data line making up said transfer path.

19. A transmitting method, comprising the steps of:
first transmitting, of image data to an external device, with multiple channels, by differential signals, via a transfer path;
second transmitting, of predetermined data to said external device, via a bi-directional communication path made up using predetermined lines of said transfer path;
responding with the existence of capability as to the confirmation of the existence of capability to transmit said predetermined data to said external device, via said bi-directional communication path; and
receiving, of transmission requests for said predetermined data from said external devices; wherein
said predetermined data is transmitted to said external device via said bi-directional communication path, upon said transmission request having been received with said transmission request receiving unit in said second transmitting.
